(19) United States
(12) Patent Application Publication
(10) Pub. No.: US 2025/0379977 A1
(43) Pub. Date: Dec. 11, 2025

(54) ADAPTIVE TRANSFORM TYPE SETS BASED ON FRAME LEVEL STATISTICS

(71) Applicant: GOOGLE LLC, Mountain View, CA (US)

(72) Inventors: Lester Lu, Los Angeles, CA (US); Debargha Mukherjee, Cupertino, CA (US)

(21) Appl. No.: 19/190,936

(22) Filed: Apr. 28, 2025

Related U.S. Application Data
(60) Provisional application No. 63/656,284, filed on Jun. 5, 2024.

(51) Int. Cl. H04N 19/12; H04N 19/154; H04N 19/176

(52) U.S. Cl. CPC H04N 19/12; H04N 19/154; H04N 19/176

(57) ABSTRACT

Encoding using adaptive transform type sets based on frame level statistics includes obtaining an encoded bitstream by encoding a current block of a current frame of a current sequence of frames of an input video stream using adaptive transform type sets based on frame level statistics and outputting the encoded bitstream. Encoding the current block includes obtaining transform type statistics for previously reconstructed reference frames from the current sequence of frames, the previously reconstructed reference frames including at least one previously reconstructed reference frame, determining, in accordance with the transform type statistics, a current subset of transform types from a set of available transform types, generating encoded block data for the current block using a current transform type from the current subset of transform types, and including the encoded block data in the encoded bitstream.

### CROSS-REFERENCE TO RELATED APPLICATION(S)

This application claims priority to and the benefit of U.S. Provisional Application Patent Ser. No. 63/656,284 filed Jun. 5, 2024, the entire disclosure of which is hereby incorporated by reference.

### BACKGROUND

Digital images and video can be used, for example, on the internet, for remote business meetings via video conferencing, high-definition video entertainment, video advertisements, or sharing of user-generated content. Due to the large amount of data involved in transferring and processing image and video data, high-performance compression may be advantageous for transmission and storage. Accordingly, it would be advantageous to provide high-resolution image and video transmitted over communications channels having limited bandwidth.

### SUMMARY

This application relates to encoding and decoding of image data, video stream data, or both for transmission, storage, or both. Disclosed herein are aspects of systems, methods, and apparatuses for encoding and decoding using adaptive transform type sets based on frame level statistics.

Variations in these and other aspects will be described in additional detail hereafter.

An aspect is a method for encoding using adaptive transform type sets based on frame level statistics. Encoding using adaptive transform type sets based on frame level statistics includes obtaining an encoded bitstream by encoding a current block of a current frame of a current sequence of frames of an input video stream using adaptive transform type sets based on frame level statistics. Encoding the current block includes obtaining transform type statistics for previously reconstructed reference frames from the current sequence of frames, the previously reconstructed reference frames including at least one previously reconstructed reference frame, determining, in accordance with the transform type statistics, a current subset of transform types from a set of available transform types, generating encoded block data for the current block using a current transform type from the current subset of transform types, and including the encoded block data in the encoded bitstream. Encoding using adaptive transform type sets based on frame level statistics includes outputting the encoded bitstream.

An aspect is an apparatus for encoding a current block of a current frame of an input video stream using adaptive transform type sets based on frame level statistics. The apparatus comprising a memory including computer executable instructions for encoding using adaptive transform type sets based on frame level statistics, and a processor that executes the instructions to obtain an encoded bitstream by encoding a current block of a current frame of a current sequence of frames of an input video stream using adaptive transform type sets based on frame level statistics. To encode the current block the processor executes the instructions to obtaining transform type statistics for previously reconstructed reference frames from the current sequence of frames, the previously reconstructed reference frames including at least one previously reconstructed reference frame, determine, in accordance with the transform type statistics, a current subset of transform types from a set of available transform types, generate encoded block data for the current block in accordance with a current transform type from the current subset of transform types, and include the encoded block data in the encoded bitstream. The processor executes the instructions to output the encoded bitstream.

An aspect is a non-transitory computer-readable storage medium having stored thereon an encoded bitstream that includes encoded block data encoded using a transform type from a subset of available transform types, wherein the subset has a cardinality determined in accordance with transform type statistics for previously reconstructed reference frames from the current sequence of frames, the previously reconstructed reference frames including at least one previously reconstructed reference frame.

An aspect is a method for decoding using adaptive transform type sets based on frame level statistics. Decoding using adaptive transform type sets based on frame level statistics includes obtaining reconstructed block data for a current block of a current frame of a current sequence of frames. Obtaining the reconstructed block data includes obtaining transform type statistics for previously reconstructed reference frames from the current sequence of frames, the previously reconstructed reference frames including at least one previously reconstructed reference frame, determining, in accordance with the transform type statistics, a current subset of transform types from a set of available transform types, and generating the reconstructed block data by decoding encoded block data using a current transform type from the current subset of transform types. Decoding using adaptive transform type sets based on frame level statistics includes outputting the reconstructed frame data.

An aspect is an apparatus for decoding using adaptive transform type sets based on frame level statistics. The apparatus comprising a memory including computer executable instructions for decoding using adaptive transform type sets based on frame level statistics, and a processor that executes the instructions to obtain reconstructed block data for a current block of a current frame of a current sequence of frames. To obtain the reconstructed block data, the processor is configured to obtain transform type statistics for previously reconstructed reference frames from the current sequence of frames, the previously reconstructed reference frames including at least one previously reconstructed reference frame, determine, in accordance with the transform type statistics, a current subset of transform types from a set of available transform types, and generate the reconstructed block data, wherein, to generate the reconstructed block data, the processor is configured to execute the instructions to decode encoded block data using a current transform type from the current subset of transform types. The processor executes the instructions to output the reconstructed frame data.

### BRIEF DESCRIPTION OF THE DRAWINGS

The description herein makes reference to the accompanying drawings wherein like reference numerals refer to like parts throughout the several views unless otherwise noted or otherwise clear from context.

FIG. 1 is a diagram of a computing device in accordance with implementations of this disclosure.

FIG. 2 is a diagram of a computing and communications system in accordance with implementations of this disclosure.

FIG. 3 is a diagram of a video stream for use in encoding and decoding in accordance with implementations of this disclosure.

FIG. 4 is a block diagram of an encoder in accordance with implementations of this disclosure.

FIG. 5 is a block diagram of a decoder in accordance with implementations of this disclosure.

FIG. 6 is a block diagram of a representation of a portion of a frame in accordance with implementations of this disclosure.

FIG. 7 is a flow diagram of an example of encoding using adaptive transform type sets based on frame level statistics in accordance with implementations of this disclosure.

FIG. 8 is a flow diagram of an example of decoding using adaptive transform type sets based on frame level statistics in accordance with implementations of this disclosure.

### DETAILED DESCRIPTION

Image and video compression schemes may include breaking an image, or frame, into smaller portions, such as blocks, and generating an output bitstream using techniques to minimize the bandwidth utilization of the information included for each block in the output. In some implementations, the information included for each block in the output may be limited by reducing spatial redundancy, reducing temporal redundancy, or a combination thereof. For example, temporal or spatial redundancies may be reduced by predicting a frame, or a portion thereof, based on information available to both the encoder and decoder, and including information representing a difference, or residual, between the predicted frame and the original frame in the encoded bitstream. The residual information may be further compressed by transforming the residual information into transform coefficients (e.g., energy compaction), quantizing the transform coefficients, and entropy coding the quantized transform coefficients. Other coding information, such as motion information, may be included in the encoded bitstream, which may include transmitting differential information based on predictions of the encoding information, which may be entropy coded to further reduce the corresponding bandwidth utilization. An encoded bitstream can be decoded to reconstruct the blocks and the source images from the limited information. In some implementations, the accuracy, efficiency, or both, of coding a block using either inter-prediction or intra-prediction may be limited.

Reducing spatial redundancy includes transforming a block, such as a residual block, into the frequency domain using a transform type from a defined set of available transform types. The set of available transform types includes a number, count, or cardinality of transform types, such as sixteen (16) transform types. The encoder identifies a current transform type from among the available transform types that minimizes the resource, such as bandwidth in the encoded bitstream, utilization as the transform type for the current portion, such as current block, of the current frame and encodes the current portion using the current transform type. The encoder signals, such as using one or more syntax elements, the current transform type, such as using a corresponding identifier, such as an index value with respect to an index of the available transform types, in the encoded bitstream. The size, number, count, or cardinality, of the set of available transform types is positively correlated to improving encoding efficiency with respect to coding block, such as residual, data, corresponding to capturing, or representing, relatively diverse block residue patterns. The size, number, count, or cardinality, of the set of available transform types is positively correlated to reducing encoding efficiency with respect to signaling the current transform type, such as on a block basis. The size, number, count, or cardinality, of the set of available transform types is positively correlated to increasing complexity, such as the processing or memory utilization, of identifying the current transform type.

To reduce complexity, increase efficiency, or both, a current, such as for encoding a current block, subset of transform types is identified from the available transform types and the current transform type for encoding the current block is identified from the subset of transform types. The current subset of transform types may include the transform types from the available transform types, or may be a proper subset, omitting, or excluding, at least one transform type from the available transform types. In some encoders, the current subset of transform types is identified in accordance with a size of the current block (block size) and a current prediction mode for the current block. Identifying the current subset of transform types in accordance with the current block size and the current prediction mode may be inefficient for some blocks.

The encoding and decoding using adaptive transform type sets based on frame level statistics described herein improves on video coding techniques, or codecs, for some frames by increasing the probability that the current subset of transform types identified for encoding the current block includes the optimal transform type for the current block corresponding to the minimal bandwidth utilization for coding the current block data. To increase the probability that the current subset of transform types identified for encoding the current block includes the optimal transform type for the current block corresponding to the minimal bandwidth utilization for coding the current block data the encoding and decoding using adaptive transform type sets based on frame level statistics described herein includes identifying the current subset of transform types for the current block in accordance with transform type statistics for at least one previously reconstructed reference frame from the current sequence of frames. The encoding and decoding using adaptive transform type sets based on frame level statistics described herein omits, or excludes, identifying the current subset of transform types for the current block in accordance with the block size and the prediction mode for the current block.

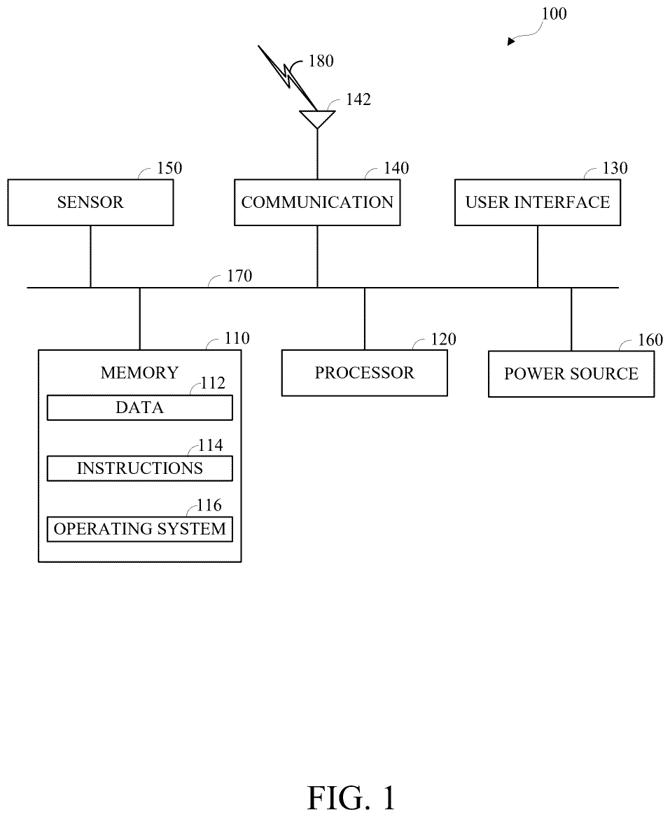

FIG. 1 is a diagram of a computing device 100 in accordance with implementations of this disclosure. The computing device 100 shown includes a memory 110, a processor 120, a user interface (UI) 130, an electronic communication unit 140, a sensor 150, a power source 160, and a bus 170. As used herein, the term “computing device” includes any unit, or a combination of units, capable of performing any method, or any portion or portions thereof, disclosed herein.

The computing device 100 may be a stationary computing device, such as a personal computer (PC), a server, a workstation, a minicomputer, or a mainframe computer; or a mobile computing device, such as a mobile telephone, a personal digital assistant (PDA), a laptop, or a tablet PC. Although shown as a single unit, any one element or elements of the computing device 100 can be integrated into any number of separate physical units. For example, the user interface 130 and processor 120 can be integrated in a first physical unit and the memory 110 can be integrated in a second physical unit.

The memory 110 can include any non-transitory computer-usable or computer-readable medium, such as any tangible device that can, for example, contain, store, communicate, or transport data 112, instructions 114, an operating system 116, or any information associated therewith, for use by or in connection with other components of the computing device 100. The non-transitory computer-usable or computer-readable medium can be, for example, a solid-state drive, a memory card, removable media, a read-only memory (ROM), a random-access memory (RAM), any type of disk including a hard disk, a floppy disk, an optical disk, a magnetic or optical card, an application-specific integrated circuits (ASICs), or any type of non-transitory media suitable for storing electronic information, or any combination thereof.

Although shown a single unit, the memory 110 may include multiple physical units, such as one or more primary memory units, such as random-access memory units, one or more secondary data storage units, such as disks, or a combination thereof. For example, the data 112, or a portion thereof, the instructions 114, or a portion thereof, or both, may be stored in a secondary storage unit and may be loaded or otherwise transferred to a primary storage unit in conjunction with processing the respective data 112, executing the respective instructions 114, or both. In some implementations, the memory 110, or a portion thereof, may be removable memory.

The data 112 can include information, such as input audio data, encoded audio data, decoded audio data, or the like. The instructions 114 can include directions, such as code, for performing any method, or any portion or portions thereof, disclosed herein. The instructions 114 can be realized in hardware, software, or any combination thereof. For example, the instructions 114 may be implemented as information stored in the memory 110, such as a computer program, which may be executed by the processor 120 to perform any of the respective methods, algorithms, aspects, or combinations thereof, as described herein.

Although shown as included in the memory 110, in some implementations, the instructions 114, or a portion thereof, may be implemented as a special purpose processor, or circuitry, that can include specialized hardware for carrying out any of the methods, algorithms, aspects, or combinations thereof, as described herein. Portions of the instructions 114 can be distributed across multiple processors on the same machine or different machines or across a network such as a local area network, a wide area network, the Internet, or a combination thereof.

The processor 120 can include any device or system capable of manipulating or processing a digital signal or other electronic information now-existing or hereafter developed, including optical processors, quantum processors, molecular processors, or a combination thereof. For example, the processor 120 can include a special purpose processor, a central processing unit (CPU), a digital signal processor (DSP), a plurality of microprocessors, one or more microprocessor in association with a DSP core, a controller, a microcontroller, an Application Specific Integrated Circuit (ASIC), a Field Programmable Gate Array (FPGA), a programmable logic array, programmable logic controller, microcode, firmware, any type of integrated circuit (IC), a state machine, or any combination thereof. As used herein, the term “processor” includes a single processor or multiple processors.

The user interface 130 can include any unit capable of interfacing with a user, such as a virtual or physical keypad, a touchpad, a display, a touch display, a speaker, a microphone, a video camera, a sensor, or any combination thereof. For example, the user interface 130 may be an audio-visual display device, and the computing device 100 may present audio, such as decoded audio, using the user interface 130 audio-visual display device, such as in conjunction with displaying video, such as decoded video. Although shown as a single unit, the user interface 130 may include one or more physical units. For example, the user interface 130 may include an audio interface for performing audio communication with a user, and a touch display for performing visual and touch-based communication with the user.

The electronic communication unit 140 can transmit, receive, or transmit and receive signals via a wired or wireless electronic communication medium 180, such as a radio frequency (RF) communication medium, an ultraviolet (UV) communication medium, a visible light communication medium, a fiber optic communication medium, a wireline communication medium, or a combination thereof. For example, as shown, the electronic communication unit 140 is operatively connected to an electronic communication interface 142, such as an antenna, configured to communicate via wireless signals.

Although the electronic communication interface 142 is shown as a wireless antenna in FIG. 1, the electronic communication interface 142 can be a wireless antenna, as shown, a wired communication port, such as an Ethernet port, an infrared port, a serial port, or any other wired or wireless unit capable of interfacing with a wired or wireless electronic communication medium 180. Although FIG. 1 shows a single electronic communication unit 140 and a single electronic communication interface 142, any number of electronic communication units and any number of electronic communication interfaces can be used.

The sensor 150 may include, for example, an audio-sensing device, a visible light-sensing device, a motion sensing device, or a combination thereof. For example, the sensor 150 may include a sound-sensing device, such as a microphone, or any other sound-sensing device now existing or hereafter developed that can sense sounds in the proximity of the computing device 100, such as speech or other utterances, made by a user operating the computing device 100. In another example, the sensor 150 may include a camera, or any other image-sensing device now existing or hereafter developed that can sense an image such as the image of a user operating the computing device. Although a single sensor 150 is shown, the computing device 100 may include a number of sensors 150. For example, the computing device 100 may include a first camera oriented with a field of view directed toward a user of the computing device 100 and a second camera oriented with a field of view directed away from the user of the computing device 100.

The power source 160 can be any suitable device for powering the computing device 100. For example, the power source 160 can include a wired external power source interface; one or more dry cell batteries, such as nickel-cadmium (NiCd), nickel-zinc (NiZn), nickel metal hydride (NiMH), lithium-ion (Li-ion); solar cells; fuel cells; or any other device capable of powering the computing device 100. Although a single power source 160 is shown in FIG. 1, the computing device 100 may include multiple power sources 160, such as a battery and a wired external power source interface.

Although shown as separate units, the electronic communication unit 140, the electronic communication interface 142, the user interface 130, the power source 160, or portions thereof, may be configured as a combined unit. For example, the electronic communication unit 140, the electronic communication interface 142, the user interface 130, and the power source 160 may be implemented as a communications port capable of interfacing with an external display device, providing communications, power, or both.

One or more of the memory 110, the processor 120, the user interface 130, the electronic communication unit 140, the sensor 150, or the power source 160, may be operatively coupled via a bus 170. Although a single bus 170 is shown in FIG. 1, a computing device 100 may include multiple buses. For example, the memory 110, the processor 120, the user interface 130, the electronic communication unit 140, the sensor 150, and the bus 170 may receive power from the power source 160 via the bus 170. In another example, the memory 110, the processor 120, the user interface 130, the electronic communication unit 140, the sensor 150, the power source 160, or a combination thereof, may communicate data, such as by sending and receiving electronic signals, via the bus 170.

Although not shown separately in FIG. 1, one or more of the processor 120, the user interface 130, the electronic communication unit 140, the sensor 150, or the power source 160 may include internal memory, such as an internal buffer or register. For example, the processor 120 may include internal memory (not shown) and may read data 112 from the memory 110 into the internal memory (not shown) for processing.

Although shown as separate elements, the memory 110, the processor 120, the user interface 130, the electronic communication unit 140, the sensor 150, the power source 160, and the bus 170, or any combination thereof can be integrated in one or more electronic units, circuits, or chips.

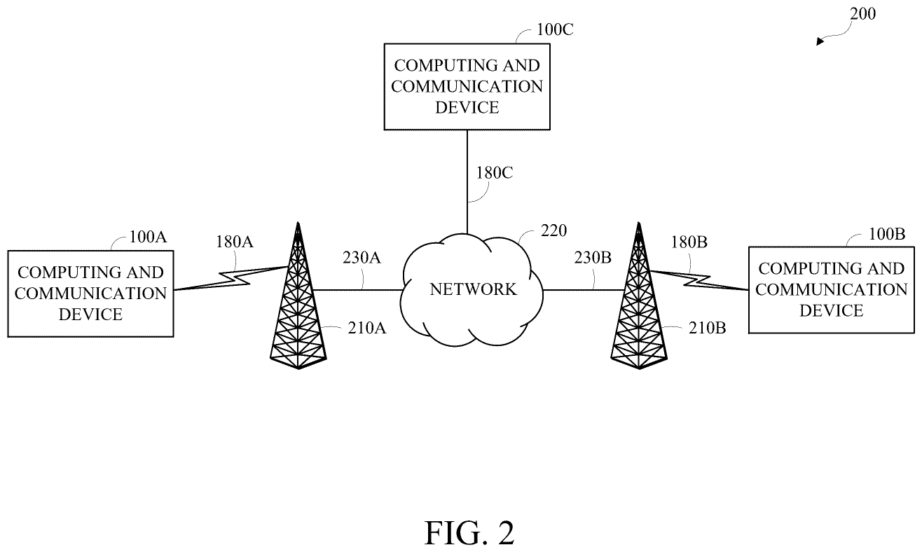

FIG. 2 is a diagram of a computing and communications system 200 in accordance with implementations of this disclosure. The computing and communications system 200 shown includes computing and communication devices 100A, 100B, 100C, access points 210A, 210B, and a network 220. For example, the computing and communication system 200 can be a multiple access system that provides communication, such as voice, audio, data, video, messaging, broadcast, or a combination thereof, to one or more wired or wireless communicating devices, such as the computing and communication devices 100A, 100B, 100C. Although, for simplicity, FIG. 2 shows three computing and communication devices 100A, 100B, 100C, two access points 210A, 210B, and one network 220, any number of computing and communication devices, access points, and networks can be used.

A computing and communication device 100A, 100B, 100C can be, for example, a computing device, such as the computing device 100 shown in FIG. 1. For example, the computing and communication devices 100A, 100B may be user devices, such as a mobile computing device, a laptop, a thin client, or a smartphone, and the computing and communication device 100C may be a server, such as a mainframe or a cluster. Although the computing and communication device 100A and the computing and communication device 100B are described as user devices, and the computing and communication device 100C is described as a server, any computing and communication device may perform some or all of the functions of a server, some, or all, of the functions of a user device, or some or all of the functions of a server and a user device. For example, the server computing and communication device 100C may receive, encode, process, store, transmit, or a combination thereof audio data and one or both of the computing and communication device 100A and the computing and communication device 100B may receive, decode, process, store, present, or a combination thereof the audio data.

Each computing and communication device 100A, 100B, 100C, which may include a user equipment (UE), a mobile station, a fixed or mobile subscriber unit, a cellular telephone, a personal computer, a tablet computer, a server, consumer electronics, or any similar device, can be configured to perform wired or wireless communication, such as via the network 220. For example, the computing and communication devices 100A, 100B, 100C can be configured to transmit or receive wired or wireless communication signals. Although each computing and communication device 100A, 100B, 100C is shown as a single unit, a computing and communication device can include any number of interconnected elements.

Each access point 210A, 210B can be any type of device configured to communicate with a computing and communication device 100A, 100B, 100C, a network 220, or both via wired or wireless communication links 180A, 180B, 180C. For example, an access point 210A, 210B can include a base station, a base transceiver station (BTS), a Node-B, an enhanced Node-B (eNode-B), a Home Node-B (HNode-B), a wireless router, a wired router, a hub, a relay, a switch, or any similar wired or wireless device. Although each access point 210A, 210B is shown as a single unit, an access point can include any number of interconnected elements.

The network 220 can be any type of network configured to provide services, such as voice, data, applications, voice over internet protocol (VOIP), or any other communications protocol or combination of communications protocols, over a wired or wireless communication link. For example, the network 220 can be a local area network (LAN), wide area network (WAN), virtual private network (VPN), a mobile or cellular telephone network, the Internet, or any other means of electronic communication. The network can use a communication protocol, such as the transmission control protocol (TCP), the user datagram protocol (UDP), the internet protocol (IP), the real-time transport protocol (RTP) the HyperText Transport Protocol (HTTP), or a combination thereof.

The computing and communication devices 100A, 100B, 100C can communicate with each other via the network 220 using one or more a wired or wireless communication links, or via a combination of wired and wireless communication links. For example, as shown the computing and communication devices 100A, 100B can communicate via wireless communication links 180A, 180B, and computing and communication device 100C can communicate via a wired communication link 180C. Any of the computing and communication devices 100A, 100B, 100C may communicate using any wired or wireless communication link, or links. For example, a first computing and communication device 100A can communicate via a first access point 210A using a first type of communication link, a second computing and communication device 100B can communicate via a second access point 210B using a second type of communication link, and a third computing and communication device 100C can communicate via a third access point (not shown) using a third type of communication link. Similarly, the access points 210A, 210B can communicate with the network 220 via one or more types of wired or wireless communication links 230A, 230B. Although FIG. 2 shows the computing and communication devices 100A, 100B, 100C in communication via the network 220, the computing and communication devices 100A, 100B, 100C can communicate with each other via any number of communication links, such as a direct wired or wireless communication link.

In some implementations, communications between one or more of the computing and communication device 100A, 100B, 100C may omit communicating via the network 220 and may include transferring data via another medium (not shown), such as a data storage device. For example, the server computing and communication device 100C may store audio data, such as encoded audio data, in a data storage device, such as a portable data storage unit, and one or both of the computing and communication device 100A or the computing and communication device 100B may access, read, or retrieve the stored audio data from the data storage unit, such as by physically disconnecting the data storage device from the server computing and communication device 100C and physically connecting the data storage device to the computing and communication device 100A or the computing and communication device 100B.

Other implementations of the computing and communications system 200 are possible. For example, in an implementation, the network 220 can be an ad-hoc network and can omit one or more of the access points 210A, 210B. The computing and communications system 200 may include devices, units, or elements not shown in FIG. 2. For example, the computing and communications system 200 may include many more communicating devices, networks, and access points.

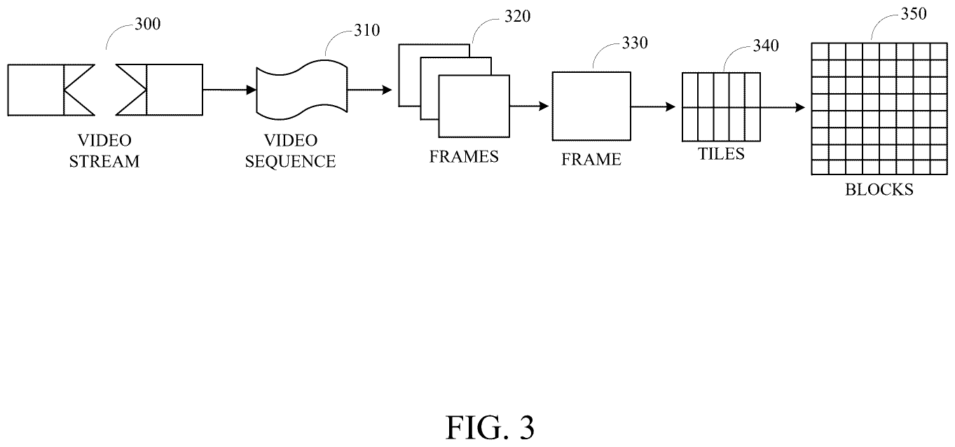

FIG. 3 is a diagram of a video stream 300 for use in encoding and decoding in accordance with implementations of this disclosure. A video stream 300, such as a video stream captured by a video camera or a video stream generated by a computing device, may include a video sequence 310. The video sequence 310 may include a sequence of adjacent frames 320. Although three adjacent frames 320 are shown, the video sequence 310 can include any number of adjacent frames 320.

Each frame 330 from the adjacent frames 320 may represent a single image from the video stream. Although not shown in FIG. 3, a frame 330 may include one or more segments, tiles, or planes, which may be coded, or otherwise processed, independently, such as in parallel. A frame 330 may include one or more tiles 340. Each of the tiles 340 may be a rectangular region of the frame that can be coded independently. Each of the tiles 340 may include respective blocks 350. Although not shown in FIG. 3, a block can include pixels. For example, a block can include a 16×16 group of pixels, an 8×8 group of pixels, an 8×16 group of pixels, or any other group of pixels. Unless otherwise indicated herein, the term ‘block’ can include a superblock, a macroblock, a segment, a slice, or any other portion of a frame. A frame, a block, a pixel, or a combination thereof can include display information, such as luminance information, chrominance information, or any other information that can be used to store, modify, communicate, or display the video stream or a portion thereof.

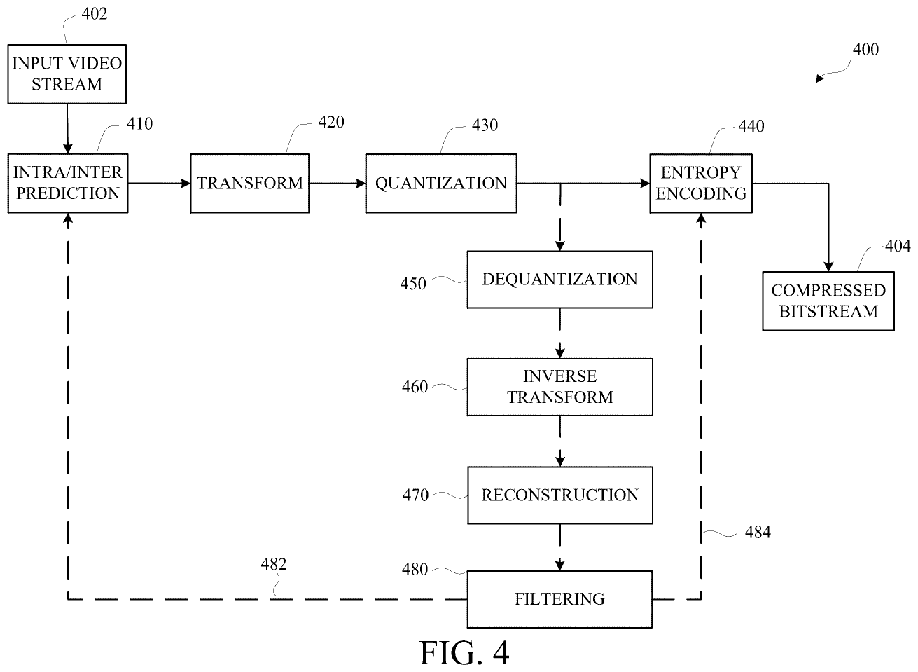

FIG. 4 is a block diagram of an encoder 400 in accordance with implementations of this disclosure. Encoder 400 can be implemented in a device, such as the computing device 100 shown in FIG. 1 or the computing and communication devices 100A, 100B, 100C shown in FIG. 2, as, for example, a computer software program stored in a data storage unit, such as the memory 110 shown in FIG. 1. The computer software program can include machine instructions that may be executed by a processor, such as the processor 120 shown in FIG. 1, and may cause the device to encode video data as described herein. The encoder 400 can be implemented as specialized hardware included, for example, in computing device 100.

The encoder 400 can encode an input video stream 402, such as the video stream 300 shown in FIG. 3, to generate an encoded (compressed) bitstream 404. In some implementations, the encoder 400 may include a forward path for generating the compressed bitstream 404. The forward path may include an intra/inter prediction unit 410, a transform unit 420, a quantization unit 430, an entropy encoding unit 440, or any combination thereof. In some implementations, the encoder 400 may include a reconstruction path (indicated by the broken connection lines) to reconstruct a frame for encoding of further blocks. The reconstruction path may include a dequantization unit 450, an inverse transform unit 460, a reconstruction unit 470, a filtering unit 480, or any combination thereof. Other structural variations of the encoder 400 can be used to encode the video stream 402.

For encoding the video stream 402, each frame within the video stream 402 can be processed in units of blocks. Thus, a current block may be identified from the blocks in a frame, and the current block may be encoded.

At the intra/inter prediction unit 410, the current block can be encoded using either intra-frame prediction, which may be within a single frame, or inter-frame prediction, which may be from frame to frame. Intra-prediction may include generating a prediction block from samples in the current frame that have been previously encoded and reconstructed. Inter-prediction may include generating a prediction block from samples in one or more previously constructed reference frames. Generating a prediction block for a current block in a current frame may include performing motion estimation to generate a motion vector indicating an appropriate reference portion of the reference frame.

The intra/inter prediction unit 410 may subtract the prediction block from the current block (raw block) to produce a residual block. The transform unit 420 may perform a block-based transform, which may include transforming the residual block into transform coefficients in, for example, the frequency domain. Examples of block-based transform types include the Karhunen-Loève Transform (KLT) type, the Discrete Cosine Transform (DCT) type, the Singular Value Decomposition Transform (SVD) type, the Asymmetric Discrete Sine Transform (ADST) type, and the identity transform type (IDTX). In an example, the DCT may include transforming a block into the frequency domain. The DCT may include using transform coefficient values based on spatial frequency, with the lowest frequency (i.e., DC) coefficient at the top-left of the matrix and the highest frequency coefficient at the bottom-right of the matrix. The transforms may be one-dimensional. For example, a transform may be applied horizontally or vertically. A transform type may indicate a two-dimensional transform that includes using a one-dimensional horizontal transform and a one-dimensional vertical transform. For example, a transform type (DCT_DCT) indicates a two-dimensional transform that includes using a one-dimensional discrete cosine transform horizontally and using a one-dimensional discrete cosine transform vertically.

The quantization unit 430 may convert the transform coefficients into discrete quantum values, which may be referred to as quantized transform coefficients or quantization levels. The quantized transform coefficients can be entropy encoded by the entropy encoding unit 440 to produce entropy-encoded coefficients. Entropy encoding can include using a probability distribution metric. The entropy-encoded coefficients and information used to decode the block, which may include the type of prediction used, motion vectors, and quantizer values, can be output to the compressed bitstream 404. The compressed bitstream 404 can be formatted using various techniques, such as run-length encoding (RLE) and zero-run coding.

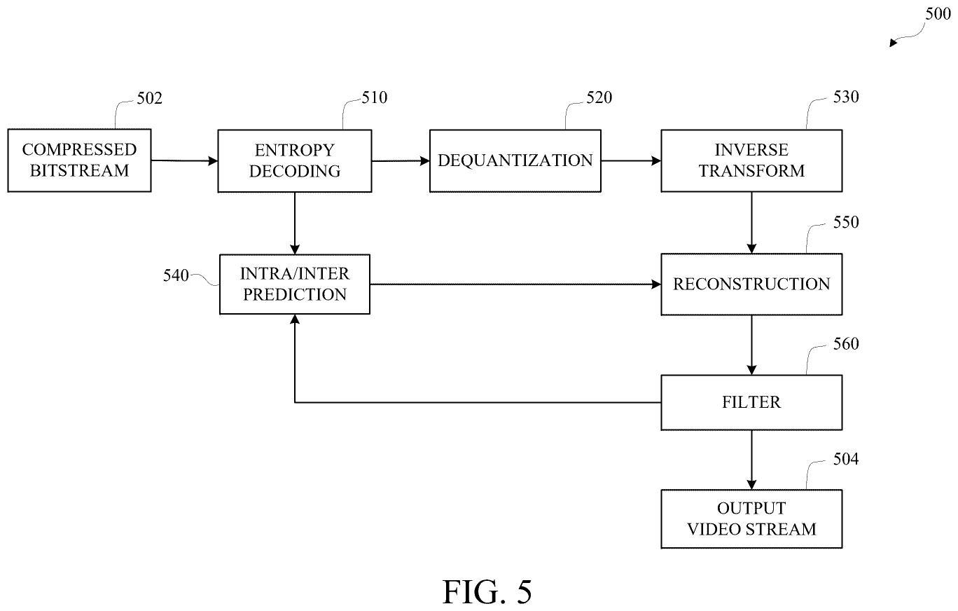

The reconstruction path can be used to maintain reference frame synchronization between the encoder 400 and a corresponding decoder, such as the decoder 500 shown in FIG. 5. The reconstruction path may be similar to the decoding process discussed below and may include decoding the encoded frame, or a portion thereof, which may include decoding an encoded block, which may include dequantizing the quantized transform coefficients at the dequantization unit 450 and inverse transforming the dequantized transform coefficients at the inverse transform unit 460 to produce a derivative residual block. The reconstruction unit 470 may add the prediction block generated by the intra/inter prediction unit 410 to the derivative residual block to create a decoded block. The filtering unit 480 can be applied to the decoded block to generate a reconstructed block, which may reduce distortion, such as blocking artifacts. Although one filtering unit 480 is shown in FIG. 4, filtering the decoded block may include loop filtering, deblocking filtering, or other types of filtering or combinations of types of filtering. The reconstructed block may be stored or otherwise made accessible as a reconstructed block, which may be a portion of a reference frame, for encoding another portion of the current frame, another frame, or both, as indicated by the broken line 482. Coding information, such as deblocking threshold index values, for the frame may be encoded, included in the compressed bitstream 404, or both, as indicated by the broken line 484.

Other variations of the encoder 400 can be used to encode the compressed bitstream 404. For example, a non-transform-based encoder 400 can quantize the residual block directly without the transform unit 420. In some implementations, the quantization unit 430 and the dequantization unit 450 may be combined into a single unit.

FIG. 5 is a block diagram of a decoder 500 in accordance with implementations of this disclosure. The decoder 500 can be implemented in a device, such as the computing device 100 shown in FIG. 1 or the computing and communication devices 100A, 100B, 100C shown in FIG. 2, as, for example, a computer software program stored in a data storage unit, such as the memory 110 shown in FIG. 1. The computer software program can include machine instructions that may be executed by a processor, such as the processor 120 shown in FIG. 1, and may cause the device to decode video data as described herein. The decoder 500 can be implemented as specialized hardware included, for example, in computing device 100.

The decoder 500 may receive a compressed bitstream 502, such as the compressed bitstream 404 shown in FIG. 4, and may decode the compressed bitstream 502 to generate an output video stream 504. The decoder 500 may include an entropy decoding unit 510, a dequantization unit 520, an inverse transform unit 530, an intra/inter prediction unit 540, a reconstruction unit 550, a filtering unit 560, or any combination thereof. Other structural variations of the decoder 500 can be used to decode the compressed bitstream 502.

The entropy decoding unit 510 may decode data elements within the compressed bitstream 502 using, for example, Context Adaptive Binary Arithmetic Decoding, to produce a set of quantized transform coefficients. The dequantization unit 520 can dequantize the quantized transform coefficients, and the inverse transform unit 530 can inverse transform the dequantized transform coefficients to produce a derivative residual block, which may correspond to the derivative residual block generated by the inverse transform unit 460 shown in FIG. 4. Using header information decoded from the compressed bitstream 502, the intra/inter prediction unit 540 may generate a prediction block corresponding to the prediction block created in the encoder 400. At the reconstruction unit 550, the prediction block can be added to the derivative residual block to create a decoded block. The filtering unit 560 can be applied to the decoded block to reduce artifacts, such as blocking artifacts, which may include loop filtering, deblocking filtering, or other types of filtering or combinations of types of filtering, and which may include generating a reconstructed block, which may be output as the output video stream 504.

Other variations of the decoder 500 can be used to decode the compressed bitstream 502. For example, the decoder 500 can produce the output video stream 504 without the deblocking filtering unit 560.

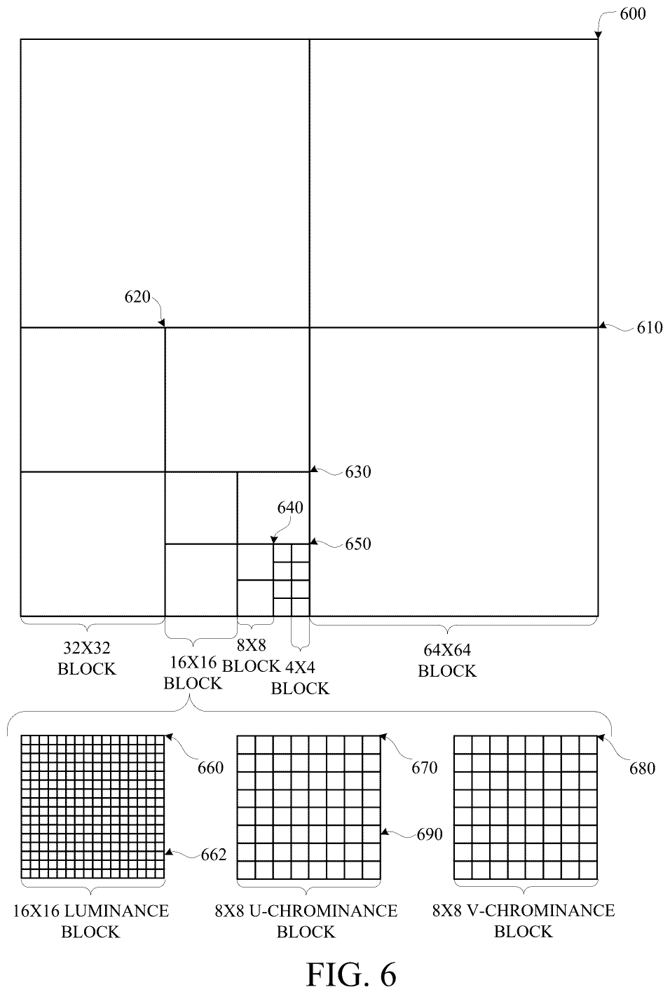

FIG. 6 is a block diagram of a representation of a portion 600 of a frame, such as the frame 330 shown in FIG. 3, in accordance with implementations of this disclosure. As shown, the portion 600 of the frame includes four 64×64 blocks 610, in two rows and two columns in a matrix or Cartesian plane. In some implementations, a 64×64 block may be a maximum coding unit, N=64. Each 64×64 block may include four 32×32 blocks 620. Each 32×32 block may include four 16×16 blocks 630. Each 16×16 block may include four 8×8 blocks 640. Each 8×8 block 640 may include four 4×4 blocks 650. Each 4×4 block 650 may include 16 pixels, which may be represented in four rows and four columns in each respective block in the Cartesian plane or matrix. The pixels may include information representing an image captured in the frame, such as luminance information, color information, and location information. In some implementations, a block, such as a 16×16 pixel block as shown, may include a luminance block 660, which may include luminance pixels 662; and two chrominance blocks 670, 680, such as a U or Cb chrominance block 670, and a V or Cr chrominance block 680. The chrominance blocks 670, 680 may include chrominance pixels 690. For example, the luminance block 660 may include 16×16 luminance pixels 662 and each chrominance block 670, 680 may include 8×8 chrominance pixels 690 as shown. Although one arrangement of blocks is shown, any arrangement may be used. Although FIG. 6 shows N×N blocks, in some implementations, N×M blocks may be used. For example, 32×64 blocks, 64×32 blocks, 16×32 blocks, 32×16 blocks, or any other size blocks may be used. In some implementations, N×2N blocks, 2N×N blocks, or a combination thereof may be used.

In some implementations, video coding may include ordered block-level coding. Ordered block-level coding may include coding blocks of a frame in an order, such as raster-scan order, wherein blocks may be identified and processed starting with a block in the upper left corner of the frame, or portion of the frame, and proceeding along rows from left to right and from the top row to the bottom row, identifying each block in turn for processing. For example, the 64×64 block in the top row and left column of a frame may be the first block coded and the 64×64 block immediately to the right of the first block may be the second block coded. The second row from the top may be the second row coded, such that the 64×64 block in the left column of the second row may be coded after the 64×64 block in the rightmost column of the first row.

In some implementations, coding a block may include using quad-tree coding, which may include coding smaller block units within a block in raster-scan order. For example, the 64×64 block shown in the bottom left corner of the portion of the frame shown in FIG. 6, may be coded using quad-tree coding wherein the top left 32×32 block may be coded, then the top right 32×32 block may be coded, then the bottom left 32×32 block may be coded, and then the bottom right 32×32 block may be coded. Each 32×32 block may be coded using quad-tree coding wherein the top left 16×16 block may be coded, then the top right 16×16 block may be coded, then the bottom left 16×16 block may be coded, and then the bottom right 16×16 block may be coded. Each 16×16 block may be coded using quad-tree coding wherein the top left 8×8 block may be coded, then the top right 8×8 block may be coded, then the bottom left 8×8 block may be coded, and then the bottom right 8×8 block may be coded. Each 8×8 block may be coded using quad-tree coding wherein the top left 4×4 block may be coded, then the top right 4×4 block may be coded, then the bottom left 4×4 block may be coded, and then the bottom right 4×4 block may be coded. In some implementations, 8×8 blocks may be omitted for a 16×16 block, and the 16×16 block may be coded using quad-tree coding wherein the top left 4×4 block may be coded, then the other 4×4 blocks in the 16×16 block may be coded in raster-scan order.

In some implementations, video coding may include compressing the information included in an original, or input, frame by, for example, omitting some of the information in the original frame from a corresponding encoded frame. For example, coding may include reducing spectral redundancy, reducing spatial redundancy, reducing temporal redundancy, or a combination thereof.

In some implementations, reducing spectral redundancy may include using a color model based on a luminance component (Y) and two chrominance components (U and V or Cb and Cr), which may be referred to as the YUV or YCbCr color model, or color space. Using the YUV color model may include using a relatively large amount of information to represent the luminance component of a portion of a frame and using a relatively small amount of information to represent each corresponding chrominance component for the portion of the frame. For example, a portion of a frame may be represented by a high-resolution luminance component, which may include a 16×16 block of pixels, and by two lower resolution chrominance components, each of which represents the portion of the frame as an 8×8 block of pixels. A pixel may indicate a value, for example, a value in the range from 0 to 255, and may be stored or transmitted using, for example, eight bits. Although this disclosure is described in reference to the YUV color model, any color model may be used.

In some implementations, reducing spatial redundancy may include transforming a block into the frequency domain using, for example, a discrete cosine transform (DCT). For example, a unit of an encoder, such as the transform unit 420 shown in FIG. 4, may perform a DCT using transform coefficient values based on spatial frequency.

In some implementations, reducing temporal redundancy may include using similarities between frames to encode a frame using a relatively small amount of data based on one or more reference frames, which may be previously encoded, decoded, and reconstructed frames of the video stream. For example, a block or pixel of a current frame may be similar to a spatially corresponding block or pixel of a reference frame. In some implementations, a block or pixel of a current frame may be similar to block or pixel of a reference frame at a different spatial location and reducing temporal redundancy may include generating motion information indicating the spatial difference, or translation, between the location of the block or pixel in the current frame and corresponding location of the block or pixel in the reference frame.

In some implementations, reducing temporal redundancy may include identifying a portion of a reference frame that corresponds to a current block or pixel of a current frame. For example, a reference frame, or a portion of a reference frame, which may be stored in memory, may be searched to identify a portion for generating a prediction to use for encoding a current block or pixel of the current frame with maximal efficiency. For example, the search may identify a portion of the reference frame for which the difference in pixel values between the current block and a prediction block generated based on the portion of the reference frame is minimized and may be referred to as motion searching. In some implementations, the portion of the reference frame searched may be limited. For example, the portion of the reference frame searched, which may be referred to as the search area, may include a limited number of rows of the reference frame. In an example, identifying the portion of the reference frame for generating a prediction may include calculating a cost function, such as a sum of absolute differences (SAD), between the pixels of portions of the search area and the pixels of the current block.

In some implementations, the spatial difference between the location of the portion of the reference frame for generating a prediction in the reference frame and the current block in the current frame may be represented as a motion vector. The difference in pixel values between the prediction block and the current block may be referred to as differential data, residual data, a prediction error, or as a residual block. In some implementations, generating motion vectors may be referred to as motion estimation, and a pixel of a current block may be indicated based on location using Cartesian coordinates as f_{x, y}. Similarly, a pixel of the search area of the reference frame may be indicated based on location using Cartesian coordinates as r_{x, y}. A motion vector (MV) for the current block may be determined based on, for example, a SAD between the pixels of the current frame and the corresponding pixels of the reference frame.

Although described herein with reference to matrix or Cartesian representation of a frame for clarity, a frame may be stored, transmitted, processed, or any combination thereof, in any data structure such that pixel values may be efficiently represented for a frame or image. For example, a frame may be stored, transmitted, processed, or any combination thereof, in a two-dimensional data structure such as a matrix as shown, or in a one-dimensional data structure, such as a vector array. In an implementation, a representation of the frame, such as a two-dimensional representation as shown, may correspond to a physical location in a rendering of the frame as an image. For example, a location in the top left corner of a block in the top left corner of the frame may correspond with a physical location in the top left corner of a rendering of the frame as an image.

In some implementations, block-based coding efficiency may be improved by partitioning input blocks into one or more prediction partitions, which may be rectangular, including square, partitions for prediction coding. In some implementations, video coding using prediction partitioning may include selecting a prediction partitioning scheme from among multiple candidate prediction partitioning schemes. For example, in some implementations, candidate prediction partitioning schemes for a 64×64 coding unit may include rectangular size prediction partitions ranging in sizes from 4×4 to 64×64, such as 4×4, 4×8, 8×4, 8×8, 8×16, 16×8, 16×16, 16×32, 32×16, 32×32, 32×64, 64×32, or 64×64. In some implementations, video coding using prediction partitioning may include a full prediction partition search, which may include selecting a prediction partitioning scheme by encoding the coding unit using each available candidate prediction partitioning scheme and selecting the best scheme, such as the scheme that produces the least rate-distortion error.

In some implementations, encoding a video frame may include identifying a prediction partitioning scheme for encoding a current block, such as block 610. In some implementations, identifying a prediction partitioning scheme may include determining whether to encode the block as a single prediction partition of maximum coding unit size, which may be 64×64 as shown, or to partition the block into multiple prediction partitions, which may correspond with the sub-blocks, such as the 32×32 blocks 620 the 16×16 blocks 630, or the 8×8 blocks 640, as shown, and may include determining whether to partition into one or more smaller prediction partitions. For example, a 64×64 block may be partitioned into four 32×32 prediction partitions. Three of the four 32×32 prediction partitions may be encoded as 32×32 prediction partitions and the fourth 32×32 prediction partition may be further partitioned into four 16×16 prediction partitions. Three of the four 16×16 prediction partitions may be encoded as 16×16 prediction partitions and the fourth 16×16 prediction partition may be further partitioned into four 8×8 prediction partitions, each of which may be encoded as an 8×8 prediction partition. In some implementations, identifying the prediction partitioning scheme may include using a prediction partitioning decision tree.

In some implementations, video coding for a current block may include identifying an optimal prediction coding mode from multiple candidate prediction coding modes, which may provide flexibility in handling video signals with various statistical properties and may improve the compression efficiency. For example, a video coder may evaluate each candidate prediction coding mode to identify the optimal prediction coding mode, which may be, for example, the prediction coding mode that minimizes an error metric, such as a rate-distortion cost, for the current block. In some implementations, the complexity of searching the candidate prediction coding modes may be reduced by limiting the set of available candidate prediction coding modes based on similarities between the current block and a corresponding prediction block. In some implementations, the complexity of searching each candidate prediction coding mode may be reduced by performing a directed refinement mode search. For example, metrics may be generated for a limited set of candidate block sizes, such as 16×16, 8×8, and 4×4, the error metric associated with each block size may be in descending order, and additional candidate block sizes, such as 4×8 and 8×4 block sizes, may be evaluated.

In some implementations, block-based coding efficiency may be improved by partitioning a current residual block into one or more transform partitions, which may be rectangular, including square, partitions for transform coding. In some implementations, video coding, such as video coding using transform partitioning, may include selecting a uniform transform partitioning scheme. For example, a current residual block, such as block 610, may be a 64×64 block and may be transformed without partitioning using a 64×64 transform.

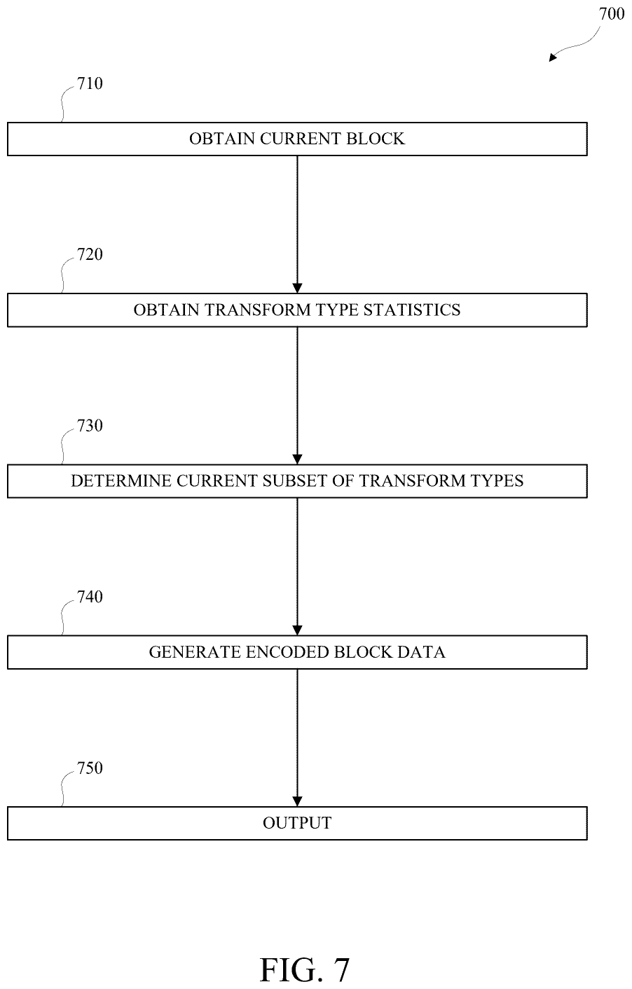

FIG. 7 is a flow diagram of an example of encoding using adaptive transform type sets based on frame level statistics 700 in accordance with implementations of this disclosure. Encoding using adaptive transform type sets based on frame level statistics 700 may be implemented by an encoder, such as the encoder 400 shown in FIG. 4.

Encoding using adaptive transform type sets based on frame level statistics 700 includes obtaining an encoded (compressed, or output) bitstream, such as the encoded (compressed or output) bitstream 404 shown in FIG. 4, by encoding an input video stream, such as the input video stream 402 shown in FIG. 4, or one or more portions thereof, such as a current frame thereof, such as the frame 330 shown in FIG. 3 using adaptive transform type sets based on frame level statistics.

In block-based hybrid video coding, to reduce, or minimize, the resource utilization, such as bandwidth utilization, for signaling, storing, or both, compressed, or encoded, video data, redundant data, such as spatially redundant data, temporally redundant data, or both, is omitted or excluded from the compressed, or encoded, data. Reducing spatial redundancy includes transforming a block, such as a residual block, into the frequency domain using a transform type from a defined set of available transform types. The set of available transform types includes a number, count, or cardinality of transform types, such as sixteen (16) transform types. The encoder identifies a current transform type from among the available transform types that minimizes the resource, such as bandwidth in the encoded bitstream, utilization as the transform type for the current portion, such as current block, of the current frame and encodes the current portion using the current transform type. The encoder signals, such as using one or more syntax elements, the current transform type, such as using a corresponding identifier, such as an index value with respect to an index of the available transform types, in the encoded bitstream.

For example, for inter prediction coding (inter coding) using a 4×4 transform, a 4×8 transform, a 8×4 transform, a 8×8 transform, a 4×16 transform, a 16×4 transform, a 8×16 transform, or a 16×8 transform, the available two-dimensional transform types include the DCT_DCT transform type, the DCT_ADST transform type, the DCT_FLIPADST transform type, the V_DCT transform type, the ADST_DCT transform type, the ADST_ADST transform type, the ADST_FLIPADST transform type, the V_ADST transform type, the FLIPADST_DCT transform type, the FLIPADST_ADST transform type, the FLIPADST_FLIPADST transform type, the V_FLIPADST transform type, the H_DCT transform type, the H_ADST transform type, the H_FLIPADST transform type, and the IDTX transform type. Other transform types may be used.

Encoding using adaptive transform type sets based on frame level statistics 700 includes obtaining a current block (at 710), obtaining transform type statistics (at 720), determining a current subset of transform types (at 730), generating encoded block data (at 740), and outputting the encoded bitstream (at 750). One or more aspects of encoding using adaptive transform type sets based on frame level statistics 700 may be omitted from the description herein for simplicity and brevity.

Input video data, such as in input video stream, is obtained (at 710). For example, the encoder, or a component thereof, obtains the input video data. The input video data includes a current sequence of frames (input frames), such as a group of pictures (GOP), from an input video stream. For example, the encoder, or a component thereof, such as an intra/inter prediction unit of the encoder, such as the intra/inter prediction unit 410 shown in FIG. 4, may obtain the input video stream.

A current frame is obtained (at 710) from the current sequence of frames. The current frame may be obtained (at 710) subsequent to encoding one or more other frames, such as a frame sequentially preceding the current frame in the input video stream, and generating, or otherwise obtaining, a corresponding reconstructed frame (or frames), or one or more portions thereof, for use as a reference frame (or frames) (previously reconstructed reference frames including at least one previously reconstructed reference frame) for encoding the current frame.

A current block is obtained (at 710) from the current frame. For example, the encoder, or a component thereof, obtains the current block (at 710). The current block may be obtained (at 710) subsequent to encoding one or more other blocks, such as a block sequentially preceding the current block in the current frame, in accordance with a block coding order for coding the current frame, and generating, or otherwise obtaining, a corresponding reconstructed block, or one or more portions thereof.

The transform types used for encoding video data may vary by a relatively large amount among respective sequences of frames. The transform types used for encoding video data may vary by a relatively small amount among respective frames within a sequence. The distribution of transform types used for encoding frames with relatively high quality (high-quality frames), such as using relatively low quantization parameters, may be diverse relative to the distribution of transform types used for encoding frames with relatively low quality (low-quality frames), such as using relatively high quantization parameters. Encoding using adaptive transform type sets based on frame level statistics 700 includes using transform type statistics obtained from encoding relatively high-quality frames to identifying a current subset of transform types for encoding blocks from relatively low-quality frames. Encoding using adaptive transform type sets based on frame level statistics 700 omits, or excludes, identifying the current subset of transform types for the current block in accordance with the block size and the prediction mode for the current block.

The transform type statistics are obtained (at 720). The transform type statistics include data indicating a distribution of the transform types, such as per-transform type counts, used for encoding the previously coded frames from the current sequence of frames that are available as reference frames for encoding the current frame (at least one previously reconstructed reference frame) wherein the quantization parameter for the current frame, such as indicated by a frame level value (base_q_idx), is low relative to the quantization parameters for the previously coded frames. The transform type statistics may be obtained for encoding the current frame prior to encoding the blocks of the current frame, such as prior to encoding a sequentially first, in block coding order, block of the current frame.

Obtaining the transform type statistics includes sorting, or ranking, the transform types indicated in the transform type statistics in accordance with the distribution, frequency-of-use, or selection frequency, of the respective transform types indicated in the transform type statistics. For example, the transform type statistics may include a data structure, such as an array, of frame level quantization parameters of the reference frames (top_qindex), which may be sorted in ascending quantization parameter order, such as from the minimal, or lowest, frame level quantization parameter at the minimal array position (top_qindex[0]), to the maximal, or highest, frame level quantization parameter.

The current subset of transform types is determined (at 730). A set of transform types (available transform types) is available for coding the current sequence of frames, such as sixteen (16) transform types. In some implementations, the current subset of transform types includes the available transform types. In some implementations, the current subset of transform types may be a proper subset of the set of available transform types, wherein a number, count, or cardinality of the current subset of transform types is less than a number, count, or cardinality of the set of available transform types.

Determining the current subset of transform types includes determining a subset cardinality (txset_class) for the current subset of transform types indicating how many transform types to include in the current subset of transform types.

In some implementations, the subset cardinality is determined in accordance with the quantization parameters for the current frame, the quantization parameters for the previously coded frames, the distribution of the transform types indicated in the transform type statistics, or a combination thereof. Other techniques may be used to determine the subset cardinality.

In an example, the number, count, or cardinality, of reference frames (num_refs) available for encoding the current frame is less than a first defined threshold, such as three, (num_refs<3), and the number, count, or cardinality, of the available transform types (ADAPT_TXSET_FULL) is identified as the subset cardinality (txset_class), which may be expressed as the following:

if (num_refs < 3)
{txset_class = ADAPT_TXSET_FULL}.

In another example, the frame level quantization parameter of the current frame (cur_qindex) is less than or equal to the frame level quantization parameters of a first defined number, count, or cardinality, of the reference frames, such as three, in ascending frame level quantization parameter order (top_qindex[2]), (cur_qindex<=top_qindex[2]), and the number, count, or cardinality, of the available transform types (ADAPT_TXSET_FULL) is identified as the subset cardinality, which may be expressed as the following:

if (cur_qindex <= top_qindex[2])
{txset_class = ADAPT_TXSET_FULL}.

In another example, the number, count, or cardinality, of reference frames (num_refs) available for encoding the current frame is greater than or equal to the first defined threshold, the frame level quantization parameter of the current frame (cur_qindex) is greater than the frame level quantization parameters of the first defined number, count, or cardinality, of the reference frames in ascending frame level quantization parameter order (top_qindex[2]), the frame level quantization parameter of the current frame (cur_qindex) is less than or equal to a second defined number, count, or cardinality, of the reference frames, such as four, in ascending frame level quantization parameter order (top_qindex[3]), (cur_qindex<=top_qindex[3]), the frame level quantization parameter of the current frame (cur_qindex) is less than or equal to a second defined threshold (qpthr) (cur_qindex<=qpthr), wherein the second defined threshold is a product of multiplying a sum of a first defined value, such as 192, and a result of subtracting eight from a bit depth for the current frame (bit_depth) by a second defined value, such as twenty-four, a number, count, or cardinality, of transform types used for encoding a reference frame having a second lowest frame level quantization parameter (num_tx_in_rank2_ref) is greater than the number, count, or cardinality, of available transform types divided by two (p50)(num_tx_in_rank2_ref>p50), and three quarters (75%) of the number, count, or cardinality, of the available transform types (ADAPT_TXSET_REDUCED), such as twelve, is identified as the subset cardinality (txset_class=ADAPT_TXSET_REDUCED), which may be expressed as the following:

if (cur_qindex <= top_qindex[3] && cur_qindex <= qpthr &&
num_tx_in_rank2_ref > p50)
{txset_class = ADAPT_TXSET_REDUCED.}

In another example, the number, count, or cardinality, of reference frames (num_refs) available for encoding the current frame is greater than or equal to the first defined threshold, the frame level quantization parameter of the current frame (cur_qindex) is greater than the frame level quantization parameters of the first defined number, count, or cardinality, of the reference frames in ascending frame level quantization parameter order (top_qindex[2]), at least one of the frame level quantization parameter of the current frame (cur_qindex) is greater than the frame level quantization parameters of the second defined number, count, or cardinality, of the reference frames in ascending frame level quantization parameter order (top_qindex[3]) or the frame level quantization parameter of the current frame (cur_qindex) is greater than the second defined threshold, the number, count, or cardinality, of transform types used for encoding a reference frame having the second lowest frame level quantization parameter (num_tx_in_rank2_ref) is greater than the number, count, or cardinality, of available transform types divided by two (p50) (num_tx_in_rank2_ref>p50), the frame level quantization parameter of the current frame (cur_qindex) is less than or equal to a third defined threshold (qpthr2) (cur_qindex<=qpthr2), wherein the third defined threshold is a product of multiplying a sum of a third defined value, such as 240, and a result of subtracting eight from the bit depth for the current frame (bit_depth) by the second defined value (cur_qindex<=qpthr2), and half (50%) of the number, count, or cardinality, of the available transform types (ADAPT_TXSET_HALF), such as eight, is identified as the subset cardinality (txset_class=ADAPT_TXSET_HALF), which may be expressed as the following:

if (num_tx_in_rank2_ref > p50 && cur_qindex <= qpthr2)
{ txset_class = ADAPT_TXSET_HALF; }.

In another example, the number, count, or cardinality, of reference frames (num_refs) available for encoding the current frame is greater than or equal to the first defined threshold, the frame level quantization parameter of the current frame (cur_qindex) is greater than the frame level quantization parameters of the first defined number, count, or cardinality, of the reference frames in ascending frame level quantization parameter order (top_qindex[2]), at least one of the frame level quantization parameter of the current frame (cur_qindex) is greater than the frame level quantization parameters of the second defined number, count, or cardinality, of the reference frames in ascending frame level quantization parameter order (top_qindex[3]) or the frame level quantization parameter of the current frame (cur_qindex) is greater than the second defined threshold, at least one of the number, count, or cardinality, of transform types used for encoding a reference frame having the second lowest frame level quantization parameter (num_tx_in_rank2_ref) is less than or equal to the number, count, or cardinality, of available transform types divided by two (p50) or the frame level quantization parameter of the current frame (cur_qindex) is greater than the third defined threshold (qpthr2), and a quarter (25%) of the number, count, or cardinality, of the available transform types (ADAPT_TXSET_ONEFOURTH), such as four, is identified as the subset cardinality (txset_class=ADAPT_TXSET_ONEFOURTH).

In some implementations, determining the subset cardinality may be expressed as the following:

if (num_refs < 3 ∥ cur_qindex <= top_qindex[2])
{ txset_class = ADAPT_TXSET_FULL; }
else if (cur_qindex <= top_qindex[3] && cur_qindex <= qpthr &&
num_tx_in_rank2_ref > p50)
{ txset_class = ADAPT_TXSET_REDUCED; }
else if (num_tx_in_rank2_ref > p50 && cur_qindex <= qpthr2)
{ txset_class = ADAPT_TXSET_HALF; }
else
{txset_class = ADAPT_TXSET_ONEFOURTH;}.

The encoded block data is generated (at 740). Generating the encoded block data includes generating entropy coded data indicating the current transform type. Generating the entropy coded data indicating the current transform type includes entropy coding a first transform type symbol and entropy coding a second transform type symbol. Entropy coding the first transform type symbol includes determining a length for, or whether to omit, the first transform type symbol in accordance with the subset cardinality (txset_class). Determining the length for, or whether to omit, the first transform type symbol in accordance with the subset cardinality reduces signaling overhead in accordance with a subset cardinality that is less than the number, count, or cardinality, of available transform types. Signaling the subset cardinality is skipped, omitted, or excluded. For example, the encoder, or a component thereof, outputs the encoded bitstream.

In an example, the number, count, or cardinality, of available transform types is sixteen, the subset cardinality is the number, count, or cardinality, of available transform types (ADAPT_TXSET_FULL), sixteen, the first transform type symbol is a quaternary (four-ary or 4-ary) symbol, and the second transform type symbol is a quaternary symbol, wherein the first transform type symbol and the second transform type symbol collectively representing the current transform type.

In another example, the number, count, or cardinality, of available transform types is sixteen, the subset cardinality is three quarters (75%) of the number, count, or cardinality, of the available transform types (ADAPT_TXSET_REDUCED), twelve, the first transform type symbol is a ternary symbol, and the second transform type symbol is a quaternary symbol, wherein the first transform type symbol and the second transform type symbol collectively representing the current transform type.

In another example, the number, count, or cardinality, of available transform types is sixteen, the subset cardinality is half (50%) of the number, count, or cardinality, of the available transform types (ADAPT_TXSET_HALF), eight, the first transform type symbol is a binary symbol, and the second transform type symbol is a quaternary symbol, wherein the first transform type symbol and the second transform type symbol collectively representing the current transform type.

In another example, the number, count, or cardinality, of available transform types is sixteen, the subset cardinality is one quarter (25%) of the number, count, or cardinality, of the available transform types (ADAPT_TXSET_ONEFOURTH), four, the first transform type symbol is skipped, omitted, or otherwise excluded from the bitstream, and the second transform type symbol is a quaternary symbol representing the current transform type in the encoded bitstream.

The entropy coded data indicating the current transform type is included in the encoded bitstream.

The output, compressed, or encoded, bitstream, is output (at 750), such as stored or transmitted, such as to a decoder.

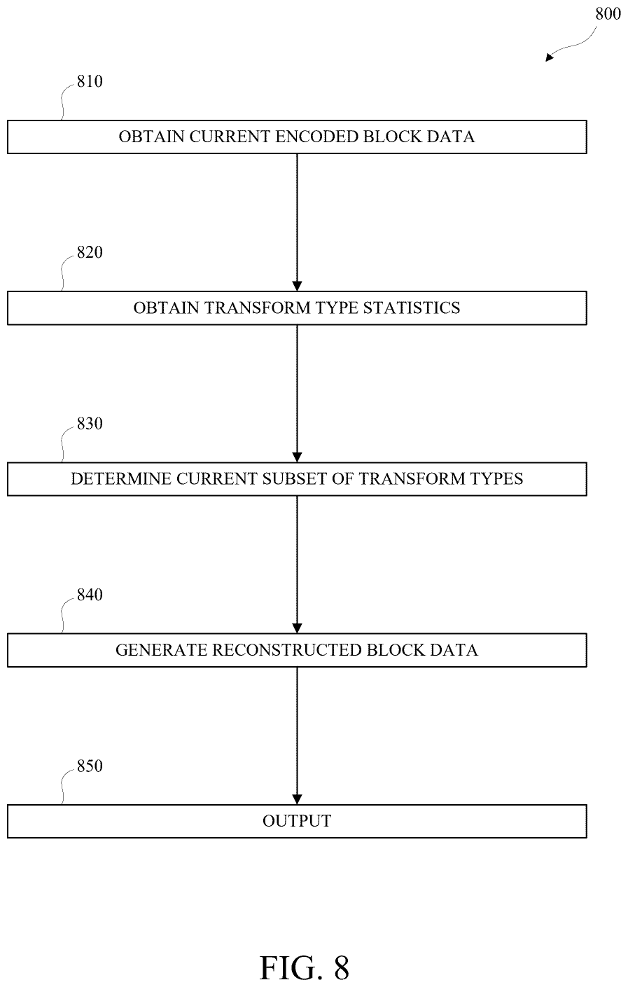

FIG. 8 is a flow diagram of an example of decoding using adaptive transform type sets based on frame level statistics 800 in accordance with implementations of this disclosure. Decoding using adaptive transform type sets based on frame level statistics 800 may be implemented in a decoder, such as the decoder 500 shown in FIG. 5. Decoding using adaptive transform type sets based on frame level statistics 800 includes, or is included in, block-based hybrid video coding as described herein.

Decoding using adaptive transform type sets based on frame level statistics 800 includes generating, or otherwise obtaining, reconstructed video data by decoding from an encoded bitstream, such as the compressed bitstream 502 shown in FIG. 5, or one or more portions thereof, using adaptive transform type sets based on frame level statistics, to generate a reconstructed video, or a portion thereof, such as the output video stream 504 shown in FIG. 5.

Decoding using adaptive transform type sets based on frame level statistics 800 includes obtaining the encoded bitstream (not expressly shown). For example, the decoder, or a component thereof, such as an intra/inter prediction unit of the decoder, such as the entropy decoding unit 510 shown in FIG. 5, may obtain the encoded bitstream. The encoded bitstream includes encoded data for a sequence of frames.

In some implementations, decoding using adaptive transform type sets based on frame level statistics 800 includes decoding the current sequence of frames, a current frame from the current sequence of frames, a current block from the current frame, a current tile from the current frame, a current superblock from the current frame, or another component of the current sequence of frames. Other portions of the encoded bitstream, such as a partition, a segment, or a region may be decoded.

Decoding using adaptive transform type sets based on frame level statistics 800 includes obtaining encoded data for a current block (at 810), obtaining transform type statistics (at 820), determining a current subset of transform types (at 830), generating reconstructed block data (at 840), and outputting reconstructed video data (at 850). One or more aspects of decoding using adaptive transform type sets based on frame level statistics 800 may be omitted from the description herein for simplicity and brevity.

Encoded data for current frame may be obtained (at 810) subsequent to decoding one or more other frames, such as a frame sequentially preceding the current frame in the video sequence, and generating, or otherwise obtaining, a corresponding reconstructed frame (or frames), or one or more portions thereof, for use as a reference frame (or frames) (previously reconstructed reference frames including at least one previously reconstructed reference frame) for decoding the current frame.

The encoded data for current block is obtained (at 810). For example, the decoder, or a component thereof, obtains the encoded data for the current block (at 810). The encoded data for the current block may be obtained (at 710) subsequent to decoding one or more other blocks, such as a block sequentially preceding the current block in the current frame, in accordance with a block coding order for coding the current frame, and generating, or otherwise obtaining, a corresponding reconstructed block, or one or more portions thereof.

The transform type statistics are obtained (at 820). Obtaining the transform type statistics (at 820) is similar to obtaining transform type statistics as shown (at 720) in FIG. 7, except as is described herein or as is otherwise clear from context.

The current subset of transform types is determined (at 830). Determining the current subset of transform types (at 830) is similar to determining a current subset of transform types as shown (at 730) in FIG. 7, except as is described herein or as is otherwise clear from context.

The reconstructed block data is generated (at 840). Generating the reconstructed block data includes accessing, from the encoded bitstream, at least one transform type symbol representing the current transform type.

In an example, the number, count, or cardinality, of available transform types is sixteen, the subset cardinality is the number, count, or cardinality, of available transform types (ADAPT_TXSET_FULL), sixteen, and accessing the at least one transform type symbol representing the current transform type includes accessing, as a first transform type symbol, a first quaternary symbol, and accessing, as a second transform type symbol, a second quaternary symbol, wherein the first transform type symbol and the second transform type symbol collectively representing the current transform type.

In another example, the number, count, or cardinality, of available transform types is sixteen, the subset cardinality is three quarters (75%) of the number, count, or cardinality, of the available transform types (ADAPT_TXSET_REDUCED), twelve, and accessing the at least one transform type symbol representing the current transform type includes accessing, as the first transform type symbol, a ternary symbol, and accessing, as the second transform type symbol, a quaternary symbol, wherein the first transform type symbol and the second transform type symbol collectively representing the current transform type.

In another example, the number, count, or cardinality, of available transform types is sixteen, the subset cardinality is half (50%) of the number, count, or cardinality, of the available transform types (ADAPT_TXSET_HALF), eight, and accessing the at least one transform type symbol representing the current transform type includes accessing, as the first transform type symbol, a binary symbol, and accessing, as the second transform type symbol, a quaternary symbol, wherein the first transform type symbol and the second transform type symbol collectively representing the current transform type.

In another example, the number, count, or cardinality, of available transform types is sixteen, the subset cardinality is one quarter (25%) of the number, count, or cardinality, of the available transform types (ADAPT_TXSET_ONEFOURTH), four, and accessing the at least one transform type symbol representing the current transform type includes accessing, as the second transform type symbol, a quaternary symbol, wherein the second transform type symbol represents the current transform type, and wherein the first transform type symbol is absent from the encoded bitstream.

Generating the reconstructed block data includes obtaining the current transform type, from the current subset of transform types, in accordance with the at least one transform type symbol, such as in accordance with a transform type identifier, or index value, indicated by the at least one transform type symbol, wherein the current transform type is an inverse of the current transform type used to encode the encoded block data as shown (at 740) in FIG. 7.

Generating the reconstructed block data includes using the current transform type, such as to transform decoded transform coefficients to the pixel, or spatial, domain.

The reconstructed video data is output, such as stored or presented, such as to a user (at 850). For example, the decoder, or a component thereof, outputs the reconstructed video data. Outputting the reconstructed video data (at 850) includes including the reconstructed block data in the reconstructed video data.

In some implementations, encoding using adaptive transform type sets based on frame level statistics includes obtaining an encoded bitstream by encoding a current block of a current frame of a current sequence of frames of an input video stream using adaptive transform type sets based on frame level statistics, wherein encoding the current block includes: obtaining transform type statistics for previously reconstructed reference frames from the current sequence of frames, the previously reconstructed reference frames including at least one previously reconstructed reference frame; determining, in accordance with the transform type statistics, a current subset of transform types from a set of available transform types; generating encoded block data for the current block using a current transform type from the current subset of transform types; and including the encoded block data in the encoded bitstream; and outputting the encoded bitstream.

In some implementations, the previously reconstructed reference frames have high quality relative to the current frame.

In some implementations, the at least one previously reconstructed reference frame has a first quantization parameter that is greater than a second quantization parameter for the current frame.

In some implementations, obtaining the transform type statistics includes: sorting the transform type statistics in descending frequency-of-use order.

In some implementations, determining the current subset of transform types includes: determining a subset cardinality for the current subset of transform types indicating how many transform types to include in the current subset of transform types.

In some implementations, determining the subset cardinality includes: determining the subset cardinality in accordance with at least one of a distribution of transform types from the transform type statistics or quantization parameters for the previously reconstructed reference frames and at least one quantization parameter for the current frame.

In some implementations, determining the subset cardinality includes: in response to determining a cardinality of the previously reconstructed reference frames is less than a first defined threshold, determining, as the subset cardinality, a cardinality of the set of available transform types.

In some implementations, determining the subset cardinality includes: in response to determining that a frame level quantization parameter of the current frame is less than or equal to the frame level quantization parameters of the first defined number, count, or cardinality, of the reference frames in ascending frame level quantization parameter order, determining, as the subset cardinality, a cardinality of the current subset of transform types.

In some implementations, encoding the current block includes: including a first quaternary symbol and a second quaternary symbol, collectively representing the current transform type, in the encoded bitstream.

In some implementations, determining the subset cardinality includes: in response to determining that: a cardinality of the previously reconstructed reference frames is greater than or equal to a first defined threshold; the frame level quantization parameter of the current frame is greater than the frame level quantization parameters of the first defined number, count, or cardinality, of the reference frames in ascending frame level quantization parameter order; the frame level quantization parameter of the current frame is less than or equal to the frame level quantization parameters of the second defined number, count, or cardinality, of the reference frames in ascending frame level quantization parameter order; the frame level quantization parameter of the current frame is less than or equal to a second defined threshold, wherein the second defined threshold is a product of multiplying a sum of one hundred ninety-two and a result of subtracting eight from a bit depth for the current frame by twenty-four; and a cardinality of transform types used for encoding a previously reconstructed reference frame from the previously reconstructed reference frames having a second lowest frame level quantization parameter is greater than a cardinality of the set of available transform types divided by two: determining, as the subset cardinality, three quarters of the cardinality of the set of available transform types.

In some implementations, encoding the current block includes: including a ternary symbol and a quaternary symbol, collectively representing the current transform type, in the encoded bitstream.

In some implementations, determining the subset cardinality includes: in response to determining that: a cardinality of the previously reconstructed reference frames is greater than or equal to a first defined threshold; the frame level quantization parameter of the current frame is greater than the frame level quantization parameters of the first defined number, count, or cardinality, of the reference frames in ascending frame level quantization parameter order; the frame level quantization parameter of the current frame is less than or equal to the frame level quantization parameters of the second defined number, count, or cardinality, of the reference frames in ascending frame level quantization parameter order; at least one of the frame level quantization parameter of the current frame is greater than the frame level quantization parameters of the second defined number, count, or cardinality, of the reference frames in ascending frame level quantization parameter order or the frame level quantization parameter of the current frame is greater than a second defined threshold, wherein the second defined threshold is a product of multiplying a sum of one hundred ninety-two and a result of subtracting eight from a bit depth for the current frame by twenty-four; a cardinality of transform types used for encoding a previously reconstructed reference frame from the previously reconstructed reference frames having a second lowest frame level quantization parameter is greater than a cardinality of the set of available transform types divided by two; and the frame level quantization parameter of the current frame is less than or equal to a third defined threshold, wherein the third defined threshold is a product of multiplying a sum of two hundred fourth and a result of subtracting eight from a bit depth for the current frame by twenty-four: determining, as the subset cardinality, half of the cardinality of the set of available transform types.

In some implementations, encoding the current block includes: including a binary symbol and a quaternary symbol, collectively representing the current transform type, in the encoded bitstream.

In some implementations, determining the subset cardinality includes: in response to determining that: a cardinality of the previously reconstructed reference frames is greater than or equal to a first defined threshold; the frame level quantization parameter of the current frame is greater than the frame level quantization parameters of the first defined number, count, or cardinality, of the reference frames in ascending frame level quantization parameter order; the frame level quantization parameter of the current frame is less than or equal to the frame level quantization parameters of the second defined number, count, or cardinality, of the reference frames in ascending frame level quantization parameter order; at least one of the frame level quantization parameter of the current frame is greater than the frame level quantization parameters of the second defined number, count, or cardinality, of the reference frames in ascending frame level quantization parameter order or the frame level quantization parameter of the current frame is greater than a second defined threshold, wherein the second defined threshold is a product of multiplying a sum of one hundred ninety-two and a result of subtracting eight from a bit depth for the current frame by twenty-four; and at least one of: a cardinality of transform types used for encoding a previously reconstructed reference frame from the previously reconstructed reference frames having a second lowest frame level quantization parameter is less than or equal to a cardinality of the set of available transform types divided by two; or the frame level quantization parameter of the current frame is greater than a third defined threshold, wherein the third defined threshold is a product of multiplying a sum of two hundred fourth and a result of subtracting eight from a bit depth for the current frame by twenty-four: determining, as the subset cardinality, a quarter of the cardinality of the set of available transform types.

In some implementations, encoding the current block includes: including a quaternary symbol representing the current transform type in the encoded bitstream.

In some implementations, decoding using adaptive transform type sets based on frame level statistics includes obtaining reconstructed block data for a current block of a current frame of a current sequence of frames, wherein obtaining the reconstructed block data includes: obtaining transform type statistics for previously reconstructed reference frames from the current sequence of frames, the previously reconstructed reference frames including at least one previously reconstructed reference frame; determining, in accordance with the transform type statistics, a current subset of transform types from a set of available transform types; and generating the reconstructed block data by decoding encoded block data using a current transform type from the current subset of transform types; and outputting the reconstructed frame data.

In some implementations, the previously reconstructed reference frames have high quality relative to the current frame.

In some implementations, the at least one previously reconstructed reference frame has a first quantization parameter that is greater than a second quantization parameter for the current frame.

In some implementations, obtaining the transform type statistics includes: sorting the transform type statistics in descending frequency-of-use order.

In some implementations, determining the current subset of transform types includes: determining a subset cardinality for the current subset of transform types indicating how many transform types to include in the current subset of transform types.

In some implementations, determining the subset cardinality includes: determining the subset cardinality in accordance with at least one of a distribution of transform types from the transform type statistics or quantization parameters for the previously reconstructed reference frames and at least one quantization parameter for the current frame.

In some implementations, determining the subset cardinality includes: in response to determining a cardinality of the previously reconstructed reference frames is less than a first defined threshold, determining, as the subset cardinality, a cardinality of the set of available transform types.

In some implementations, determining the subset cardinality includes: in response to determining that a frame level quantization parameter of the current frame is less than or equal to the frame level quantization parameters of the first defined number, count, or cardinality, of the reference frames in ascending frame level quantization parameter order, determining, as the subset cardinality, a cardinality of the current subset of transform types.

In some implementations, encoding the current block includes: including a first quaternary symbol and a second quaternary symbol, collectively representing the current transform type, in the encoded bitstream.

In some implementations, determining the subset cardinality includes: in response to determining that: a cardinality of the previously reconstructed reference frames is greater than or equal to a first defined threshold; the frame level quantization parameter of the current frame is greater than the frame level quantization parameters of the first defined number, count, or cardinality, of the reference frames in ascending frame level quantization parameter order; the frame level quantization parameter of the current frame is less than or equal to the frame level quantization parameters of the second defined number, count, or cardinality, of the reference frames in ascending frame level quantization parameter order; the frame level quantization parameter of the current frame is less than or equal to a second defined threshold, wherein the second defined threshold is a product of multiplying a sum of one hundred ninety-two and a result of subtracting eight from a bit depth for the current frame by twenty-four; and a cardinality of transform types used for encoding a previously reconstructed reference frame from the previously reconstructed reference frames having a second lowest frame level quantization parameter is greater than a cardinality of the set of available transform types divided by two: determining, as the subset cardinality, three quarters of the cardinality of the set of available transform types.

In some implementations, encoding the current block includes: including a ternary symbol and a quaternary symbol, collectively representing the current transform type, in the encoded bitstream.

In some implementations, determining the subset cardinality includes: in response to determining that: a cardinality of the previously reconstructed reference frames is greater than or equal to a first defined threshold; the frame level quantization parameter of the current frame is greater than the frame level quantization parameters of the first defined number, count, or cardinality, of the reference frames in ascending frame level quantization parameter order; the frame level quantization parameter of the current frame is less than or equal to the frame level quantization parameters of the second defined number, count, or cardinality, of the reference frames in ascending frame level quantization parameter order; at least one of the frame level quantization parameter of the current frame is greater than the frame level quantization parameters of the second defined number, count, or cardinality, of the reference frames in ascending frame level quantization parameter order or the frame level quantization parameter of the current frame is greater than a second defined threshold, wherein the second defined threshold is a product of multiplying a sum of one hundred ninety-two and a result of subtracting eight from a bit depth for the current frame by twenty-four; a cardinality of transform types used for encoding a previously reconstructed reference frame from the previously reconstructed reference frames having a second lowest frame level quantization parameter is greater than a cardinality of the set of available transform types divided by two; and the frame level quantization parameter of the current frame is less than or equal to a third defined threshold, wherein the third defined threshold is a product of multiplying a sum of two hundred fourth and a result of subtracting eight from a bit depth for the current frame by twenty-four: determining, as the subset cardinality, half of the cardinality of the set of available transform types.

In some implementations, encoding the current block includes: including a binary symbol and a quaternary symbol, collectively representing the current transform type, in the encoded bitstream.

In some implementations, determining the subset cardinality includes: in response to determining that: a cardinality of the previously reconstructed reference frames is greater than or equal to a first defined threshold; the frame level quantization parameter of the current frame is greater than the frame level quantization parameters of the first defined number, count, or cardinality, of the reference frames in ascending frame level quantization parameter order; the frame level quantization parameter of the current frame is less than or equal to the frame level quantization parameters of the second defined number, count, or cardinality, of the reference frames in ascending frame level quantization parameter order; at least one of the frame level quantization parameter of the current frame is greater than the frame level quantization parameters of the second defined number, count, or cardinality, of the reference frames in ascending frame level quantization parameter order or the frame level quantization parameter of the current frame is greater than a second defined threshold, wherein the second defined threshold is a product of multiplying a sum of one hundred ninety-two and a result of subtracting eight from a bit depth for the current frame by twenty-four; and at least one of: a cardinality of transform types used for encoding a previously reconstructed reference frame from the previously reconstructed reference frames having a second lowest frame level quantization parameter is less than or equal to a cardinality of the set of available transform types divided by two; or the frame level quantization parameter of the current frame is greater than a third defined threshold, wherein the third defined threshold is a product of multiplying a sum of two hundred fourth and a result of subtracting eight from a bit depth for the current frame by twenty-four: determining, as the subset cardinality, a quarter of the cardinality of the set of available transform types.

In some implementations, encoding the current block includes: including a quaternary symbol representing the current transform type in the encoded bitstream.

In some implementations, a non-transitory computer-readable storage medium stores an encoded bitstream including encoded block data encoded using a transform type from a subset of available transform types, wherein the subset has a cardinality determined in accordance with transform type statistics for previously reconstructed reference frames from the current sequence of frames, the previously reconstructed reference frames including at least one previously reconstructed reference frame.

In some implementations, the encoded bitstream includes: a first quaternary symbol and a second quaternary symbol, collectively representing the transform type.

In some implementations, wherein the encoded bitstream includes: a ternary symbol and a quaternary symbol, collectively representing the transform type.

In some implementations, the encoded bitstream includes: a binary symbol and a quaternary symbol, collectively representing the transform type.

In some implementations, the encoded bitstream includes: a quaternary symbol representing the transform type.

In some implementations, an apparatus includes: a memory having stored thereon instructions; and a processor configured to execute the instructions to: obtain an encoded bitstream, wherein, to obtain the encoded bitstream, the processor is configured to execute the instructions to encode a current block of a current frame of a current sequence of frames of an input video stream, wherein, to encode the current block, the processor is configured to execute the instructions to use adaptive transform type sets based on frame level statistics, wherein, to encode the current block the processor executes the instructions to: obtain transform type statistics for previously reconstructed reference frames from the current sequence of frames, the previously reconstructed reference frames including at least one previously reconstructed reference frame; determine, in accordance with the transform type statistics, a current subset of transform types from a set of available transform types; generate encoded block data for the current block in accordance with a current transform type from the current subset of transform types; and include the encoded block data in the encoded bitstream; and output the encoded bitstream.

In some implementations, the previously reconstructed reference frames have high quality relative to the current frame.

In some implementations, the at least one previously reconstructed reference frame has a first quantization parameter that is greater than a second quantization parameter for the current frame.

In some implementations, to obtain the transform type statistics, the processor is configured to: sort the transform type statistics in descending frequency-of-use order.

In some implementations, to determine the current subset of transform types, the processor is configured to: determine a subset cardinality for the current subset of transform types indicating how many transform types to include in the current subset of transform types.

In some implementations, to determine the current subset of transform types, the processor is configured to: determine the subset cardinality in accordance with at least one of a distribution of transform types from the transform type statistics or quantization parameters for the previously reconstructed reference frames and at least one quantization parameter for the current frame.

In some implementations, to determine the current subset of transform types, the processor is configured to: in response to a determination that a cardinality of the previously reconstructed reference frames is less than a first defined threshold, determine, as the subset cardinality, a cardinality of the set of available transform types.

In some implementations, to determine the current subset of transform types, the processor is configured to: in response to a determination that a frame level quantization parameter of the current frame is less than or equal to the frame level quantization parameters of the first defined number, count, or cardinality, of the reference frames in ascending frame level quantization parameter order, determine, as the subset cardinality, a cardinality of the current subset of transform types.

In some implementations, to encode the current block, the processor is configured to: include a first quaternary symbol and a second quaternary symbol, collectively representing the current transform type, in the encoded bitstream.

In some implementations, to determine the subset cardinality, the processor is configured to: in response to a determination that: a cardinality of the previously reconstructed reference frames is greater than or equal to a first defined threshold; the frame level quantization parameter of the current frame is greater than the frame level quantization parameters of the first defined number, count, or cardinality, of the reference frames in ascending frame level quantization parameter order; the frame level quantization parameter of the current frame is less than or equal to the frame level quantization parameters of the second defined number, count, or cardinality, of the reference frames in ascending frame level quantization parameter order; the frame level quantization parameter of the current frame is less than or equal to a second defined threshold, wherein the second defined threshold is a product of multiplication of a sum of one hundred ninety-two and a result of subtraction of eight from a bit depth for the current frame by twenty-four; and a cardinality of transform types used to encode a previously reconstructed reference frame from the previously reconstructed reference frames having a second lowest frame level quantization parameter is greater than a cardinality of the set of available transform types divided by two: determine, as the subset cardinality, three quarters of the cardinality of the set of available transform types.

In some implementations, to encode the current block, the processor is configured to: include a ternary symbol and a quaternary symbol, collectively representing the current transform type, in the encoded bitstream.

In some implementations, to determine the subset cardinality, the processor is configured to: in response to a determination that: a cardinality of the previously reconstructed reference frames is greater than or equal to a first defined threshold; the frame level quantization parameter of the current frame is greater than the frame level quantization parameters of the first defined number, count, or cardinality, of the reference frames in ascending frame level quantization parameter order; the frame level quantization parameter of the current frame is less than or equal to the frame level quantization parameters of the second defined number, count, or cardinality, of the reference frames in ascending frame level quantization parameter order; at least one of the frame level quantization parameter of the current frame is greater than the frame level quantization parameters of the second defined number, count, or cardinality, of the reference frames in ascending frame level quantization parameter order or the frame level quantization parameter of the current frame is greater than a second defined threshold, wherein the second defined threshold is a product of multiplication of a sum of one hundred ninety-two and a result of subtraction of eight from a bit depth for the current frame by twenty-four; a cardinality of transform types used to encode a previously reconstructed reference frame from the previously reconstructed reference frames having a second lowest frame level quantization parameter is greater than a cardinality of the set of available transform types divided by two; and the frame level quantization parameter of the current frame is less than or equal to a third defined threshold, wherein the third defined threshold is a product of multiplication of a sum of two hundred fourth and a result of subtraction of eight from a bit depth for the current frame by twenty-four: determine, as the subset cardinality, half of the cardinality of the set of available transform types.

In some implementations, to encode the current block, the processor is configured to: include a binary symbol and a quaternary symbol, collectively representing the current transform type, in the encoded bitstream.

In some implementations, to determine the subset cardinality, the processor is configured to: in response to a determination that: a cardinality of the previously reconstructed reference frames is greater than or equal to a first defined threshold; the frame level quantization parameter of the current frame is greater than the frame level quantization parameters of the first defined number, count, or cardinality, of the reference frames in ascending frame level quantization parameter order; the frame level quantization parameter of the current frame is less than or equal to the frame level quantization parameters of the second defined number, count, or cardinality, of the reference frames in ascending frame level quantization parameter order; at least one of the frame level quantization parameter of the current frame is greater than the frame level quantization parameters of the second defined number, count, or cardinality, of the reference frames in ascending frame level quantization parameter order or the frame level quantization parameter of the current frame is greater than a second defined threshold, wherein the second defined threshold is a product of multiplication of a sum of one hundred ninety-two and a result of subtraction of eight from a bit depth for the current frame by twenty-four; and at least one of: a cardinality of transform types used to encode a previously reconstructed reference frame from the previously reconstructed reference frames having a second lowest frame level quantization parameter is less than or equal to a cardinality of the set of available transform types divided by two; or the frame level quantization parameter of the current frame is greater than a third defined threshold, wherein the third defined threshold is a product of multiplication of a sum of two hundred fourth and a result of subtraction of eight from a bit depth for the current frame by twenty-four: determine, as the subset cardinality, a quarter of the cardinality of the set of available transform types.

In some implementations, to encode the current block, the processor is configured to: include a quaternary symbol representing the current transform type in the encoded bitstream.

In some implementations, an apparatus includes: a memory having stored thereon instructions; and a processor configured to execute the instructions to: obtain reconstructed block data for a current block of a current frame of a current sequence of frames, wherein, to obtain the reconstructed block data, the processor is configured to: obtain transform type statistics for previously reconstructed reference frames from the current sequence of frames, the previously reconstructed reference frames including at least one previously reconstructed reference frame; determine, in accordance with the transform type statistics, a current subset of transform types from a set of available transform types; and generate the reconstructed block data, wherein, to generate the reconstructed block data, the processor is configured to execute the instructions to decode encoded block data in accordance with a current transform type from the current subset of transform types; and output the reconstructed frame data.

In some implementations, the previously reconstructed reference frames have high quality relative to the current frame.

In some implementations, the at least one previously reconstructed reference frame has a first quantization parameter that is greater than a second quantization parameter for the current frame.

In some implementations, to obtain the transform type statistics, the processor is configured to: sort the transform type statistics in descending frequency-of-use order.

In some implementations, to determine the current subset of transform types, the processor is configured to: determine a subset cardinality for the current subset of transform types that indicates how many transform types to include in the current subset of transform types.

In some implementations, to determine the subset cardinality, the processor is configured to: determine the subset cardinality in accordance with at least one of a distribution of transform types from the transform type statistics or quantization parameters for the previously reconstructed reference frames and at least one quantization parameter for the current frame.

In some implementations, to determine the subset cardinality, the processor is configured to: in response to a determination that a cardinality of the previously reconstructed reference frames is less than a first defined threshold, determine, as the subset cardinality, a cardinality of the set of available transform types.

In some implementations, to determine the subset cardinality, the processor is configured to: in response to a determination that a frame level quantization parameter of the current frame is less than or equal to the frame level quantization parameters of the first defined number, count, or cardinality, of the reference frames in ascending frame level quantization parameter order, determine, as the subset cardinality, a cardinality of the current subset of transform types.

In some implementations, to encode the current block, the processor is configured to: include a first quaternary symbol and a second quaternary symbol, collectively representing the current transform type, in the encoded bitstream.

In some implementations, to determine the subset cardinality, the processor is configured to: in response to a determination that: a cardinality of the previously reconstructed reference frames is greater than or equal to a first defined threshold; the frame level quantization parameter of the current frame is greater than the frame level quantization parameters of the first defined number, count, or cardinality, of the reference frames in ascending frame level quantization parameter order; the frame level quantization parameter of the current frame is less than or equal to the frame level quantization parameters of the second defined number, count, or cardinality, of the reference frames in ascending frame level quantization parameter order; the frame level quantization parameter of the current frame is less than or equal to a second defined threshold, wherein the second defined threshold is a product of multiplication of a sum of one hundred ninety-two and a result of subtraction of eight from a bit depth for the current frame by twenty-four; and a cardinality of transform types used to encode a previously reconstructed reference frame from the previously reconstructed reference frames having a second lowest frame level quantization parameter is greater than a cardinality of the set of available transform types divided by two: determine, as the subset cardinality, three quarters of the cardinality of the set of available transform types.

In some implementations, to encode the current block, the processor is configured to: include a ternary symbol and a quaternary symbol, collectively representing the current transform type, in the encoded bitstream.

In some implementations, to determine the subset cardinality, the processor is configured to: in response to a determination that: a cardinality of the previously reconstructed reference frames is greater than or equal to a first defined threshold; the frame level quantization parameter of the current frame is greater than the frame level quantization parameters of the first defined number, count, or cardinality, of the reference frames in ascending frame level quantization parameter order; the frame level quantization parameter of the current frame is less than or equal to the frame level quantization parameters of the second defined number, count, or cardinality, of the reference frames in ascending frame level quantization parameter order; at least one of the frame level quantization parameter of the current frame is greater than the frame level quantization parameters of the second defined number, count, or cardinality, of the reference frames in ascending frame level quantization parameter order or the frame level quantization parameter of the current frame is greater than a second defined threshold, wherein the second defined threshold is a product of multiplication of a sum of one hundred ninety-two and a result of subtraction of eight from a bit depth for the current frame by twenty-four; a cardinality of transform types used to encode a previously reconstructed reference frame from the previously reconstructed reference frames having a second lowest frame level quantization parameter is greater than a cardinality of the set of available transform types divided by two; and the frame level quantization parameter of the current frame is less than or equal to a third defined threshold, wherein the third defined threshold is a product of multiplication of a sum of two hundred fourth and a result of subtraction of eight from a bit depth for the current frame by twenty-four: determine, as the subset cardinality, half of the cardinality of the set of available transform types.

In some implementations, to encode the current block, the processor is configured to: include a binary symbol and a quaternary symbol, collectively representing the current transform type, in the encoded bitstream.

In some implementations, to determine the subset cardinality, the processor is configured to: in response to a determination that: a cardinality of the previously reconstructed reference frames is greater than or equal to a first defined threshold; the frame level quantization parameter of the current frame is greater than the frame level quantization parameters of the first defined number, count, or cardinality, of the reference frames in ascending frame level quantization parameter order; the frame level quantization parameter of the current frame is less than or equal to the frame level quantization parameters of the second defined number, count, or cardinality, of the reference frames in ascending frame level quantization parameter order; at least one of the frame level quantization parameter of the current frame is greater than the frame level quantization parameters of the second defined number, count, or cardinality, of the reference frames in ascending frame level quantization parameter order or the frame level quantization parameter of the current frame is greater than a second defined threshold, wherein the second defined threshold is a product of multiplication of a sum of one hundred ninety-two and a result of subtraction of eight from a bit depth for the current frame by twenty-four; and at least one of: a cardinality of transform types used to encode a previously reconstructed reference frame from the previously reconstructed reference frames having a second lowest frame level quantization parameter is less than or equal to a cardinality of the set of available transform types divided by two; or the frame level quantization parameter of the current frame is greater than a third defined threshold, wherein the third defined threshold is a product of multiplication of a sum of two hundred fourth and a result of subtraction of eight from a bit depth for the current frame by twenty-four: determine, as the subset cardinality, a quarter of the cardinality of the set of available transform types.

In some implementations, to encode the current block, the processor is configured to: include a quaternary symbol representing the current transform type in the encoded bitstream.

As used herein, the terms “optimal”, “optimized”, “optimization”, or other forms thereof, are relative to a respective context and are not indicative of absolute theoretic optimization unless expressly specified herein.

As used herein, the term “set” indicates a distinguishable collection or grouping of zero or more distinct elements or members that may be represented as a one-dimensional array or vector, except as expressly described herein or otherwise clear from context.

The words “example” or “exemplary” are used herein to mean serving as an example, instance, or illustration. Any aspect or design described herein as “example” or “exemplary” not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or”. That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an embodiment” or “one embodiment” or “an implementation” or “one implementation” throughout is not intended to mean the same embodiment or implementation unless described as such.

As used herein, the terms “determine” and “identify”, or any variations thereof, includes selecting, ascertaining, computing, looking up, receiving, determining, establishing, obtaining, or otherwise identifying or determining in any manner whatsoever using one or more of the devices shown in FIG. 1. As used herein, the term “obtain”, or any variation thereof, includes selecting, ascertaining, computing, looking up, receiving, determining, establishing, accessing, reading, calculating, generating, or otherwise identifying in any manner whatsoever using one or more of the devices shown in FIG. 1, or one or more components thereof. As used herein, the term “access”, or any variation thereof, includes selecting, ascertaining, computing, looking up, receiving, determining, obtaining, reading, calculating, extracting, or otherwise identifying in any manner whatsoever using one or more of the devices shown in FIG. 1, or one or more components thereof. As used herein, the terminology “generating”, or any variations thereof, includes combining, calculating, computing, aggregating, rendering, laying out, drawing, or otherwise producing in any manner whatsoever using one or more of the devices shown and described herein. As used herein, the terminology “receiving” includes receiving via a network, retrieving from memory, or otherwise ascertaining the identified information.

Further, for simplicity of explanation, although the figures and descriptions herein may include sequences or series of steps or stages, elements of the methods disclosed herein can occur in various orders and/or concurrently. Additionally, elements of the methods disclosed herein may occur with other elements not explicitly presented and described herein. Furthermore, one or more elements of the methods described herein may be omitted from implementations of methods in accordance with the disclosed subject matter.

The implementations of the transmitting computing and communication device 100A and/or the receiving computing and communication device 100B (and the algorithms, methods, instructions, etc. stored thereon and/or executed thereby) can be realized in hardware, software, or any combination thereof. The hardware can include, for example, computers, intellectual property (IP) cores, application-specific integrated circuits (ASICs), programmable logic arrays, optical processors, programmable logic controllers, microcode, microcontrollers, servers, microprocessors, digital signal processors or any other suitable circuit. In the claims, the term “processor” should be understood as encompassing any of the foregoing hardware, either singly or in combination. The terms “signal” and “data” are used interchangeably. Further, portions of the transmitting computing and communication device 100A and the receiving computing and communication device 100B do not necessarily have to be implemented in the same manner.

Further, in one implementation, for example, the transmitting computing and communication device 100A or the receiving computing and communication device 100B can be implemented using a computer program that, when executed, carries out any of the respective methods, algorithms and/or instructions described herein. In addition, or alternatively, for example, a special purpose computer/processor can be utilized which can contain specialized hardware for carrying out any of the methods, algorithms, or instructions described herein.

The transmitting computing and communication device 100A and receiving computing and communication device 100B can, for example, be implemented on computers in a real-time video system. Alternatively, the transmitting computing and communication device 100A can be implemented on a server and the receiving computing and communication device 100B can be implemented on a device separate from the server, such as a hand-held communications device. In this instance, the transmitting computing and communication device 100A can encode content using an encoder 400 into an encoded video signal and transmit the encoded video signal to the communications device. In turn, the communications device can then decode the encoded video signal using a decoder 500. Alternatively, the communications device can decode content stored locally on the communications device, for example, content that was not transmitted by the transmitting computing and communication device 100A. Other suitable transmitting computing and communication device 100A and receiving computing and communication device 100B implementation schemes are available. For example, the receiving computing and communication device 100B can be a generally stationary personal computer rather than a portable communications device and/or a device including an encoder 400 may also include a decoder 500.

Further, all or a portion of implementations can take the form of a computer program product accessible from, for example, a tangible computer-usable or computer-readable medium. A computer-usable or computer-readable medium can be any device that can, for example, tangibly contain, store, communicate, or transport the program for use by or in connection with any processor. The medium can be, for example, an electronic, magnetic, optical, electromagnetic, or a semiconductor device. Other suitable mediums are also available.

It will be appreciated that aspects can be implemented in any convenient form. For example, aspects may be implemented by appropriate computer programs which may be carried on appropriate carrier media which may be tangible carrier media (e.g., disks) or intangible carrier media (e.g. communications signals). Aspects may also be implemented using suitable apparatus which may take the form of programmable computers running computer programs arranged to implement the methods and/or techniques disclosed herein. Aspects can be combined such that features described in the context of one aspect may be implemented in another aspect.

The above-described implementations have been described in order to allow easy understanding of the application are not limiting. On the contrary, the application covers various modifications and equivalent arrangements included within the scope of the appended claims, which scope is to be accorded the broadest interpretation so as to encompass all such modifications and equivalent structure as is permitted under the law.

What is claimed is:

1. A method comprising:
obtaining reconstructed block data for a current block of a current frame of a current sequence of frames, wherein obtaining the reconstructed block data includes:
obtaining transform type statistics for previously reconstructed reference frames from the current sequence of frames, the previously reconstructed reference frames including at least one previously reconstructed reference frame;
determining, in accordance with the transform type statistics, a current subset of transform types from a set of available transform types; and
generating the reconstructed block data by decoding encoded block data obtained from an encoded bitstream using a current transform type from the current subset of transform types; and
outputting the reconstructed block data.

2. The method of claim 1, wherein the previously reconstructed reference frames have high quality relative to the current frame.

3. The method of claim 1, wherein the at least one previously reconstructed reference frame has a first quantization parameter that is greater than a second quantization parameter for the current frame.

4. The method of claim 1, wherein obtaining the transform type statistics includes:
sorting the transform type statistics in descending frequency-of-use order.

5. The method of claim 1, wherein determining the current subset of transform types includes:
determining a subset cardinality for the current subset of transform types indicating how many transform types to include in the current subset of transform types.

6. The method of claim 5, wherein determining the subset cardinality includes:
determining the subset cardinality in accordance with at least one of a distribution of transform types from the transform type statistics or quantization parameters for the previously reconstructed reference frames and at least one quantization parameter for the current frame.

7. The method of claim 5, wherein determining the subset cardinality includes:
in response to determining a cardinality of the previously reconstructed reference frames is less than a first defined threshold, determining, as the subset cardinality, a cardinality of the set of available transform types.

8. The method of claim 5, wherein determining the subset cardinality includes:
in response to determining that a frame level quantization parameter of the current frame is less than or equal to frame level quantization parameters of a first defined cardinality of the previously reconstructed reference frames in ascending frame level quantization parameter order, determining, as the subset cardinality, a cardinality of the current subset of transform types.

9. The method of claim 8, wherein obtaining the reconstructed block data includes:
accessing a first quaternary symbol and a second quaternary symbol, collectively representing the current transform type, from the encoded bitstream.

10. The method of claim 8, wherein determining the subset cardinality includes:
in response to determining that:
a cardinality of the previously reconstructed reference frames is greater than or equal to a first defined threshold;
the frame level quantization parameter of the current frame is greater than the frame level quantization parameters of the first defined cardinality of the previously reconstructed reference frames in ascending frame level quantization parameter order;
the frame level quantization parameter of the current frame is less than or equal to the frame level quantization parameters of a second defined cardinality of the previously reconstructed reference frames in ascending frame level quantization parameter order;
the frame level quantization parameter of the current frame is less than or equal to a second defined threshold, wherein the second defined threshold is a product of multiplying a sum of one hundred ninety-two and a result of subtracting eight from a bit depth for the current frame by twenty-four; and
a cardinality of transform types used for encoding a previously reconstructed reference frame from the previously reconstructed reference frames having a second lowest frame level quantization parameter is greater than a cardinality of the set of available transform types divided by two,
determining, as the subset cardinality, three quarters of the cardinality of the set of available transform types.

11. The method of claim 10, wherein obtaining the reconstructed block data includes:
accessing a ternary symbol and a quaternary symbol, collectively representing the current transform type, from the encoded bitstream.

12. The method of claim 8, wherein determining the subset cardinality includes:
in response to determining that:
a cardinality of the previously reconstructed reference frames is greater than or equal to a first defined threshold;
the frame level quantization parameter of the current frame is greater than the frame level quantization parameters of the first defined cardinality of the previously reconstructed reference frames in ascending frame level quantization parameter order;
the frame level quantization parameter of the current frame is less than or equal to the frame level quantization parameters of a second defined cardinality of the previously reconstructed reference frames in ascending frame level quantization parameter order;
at least one of the frame level quantization parameter of the current frame is greater than the frame level quantization parameters of the second defined cardinality of the previously reconstructed reference frames in ascending frame level quantization parameter order or the frame level quantization parameter of the current frame is greater than a second defined threshold, wherein the second defined threshold is a product of multiplying a sum of one hundred ninety-two and a result of subtracting eight from a bit depth for the current frame by twenty-four;
a cardinality of transform types used for encoding a previously reconstructed reference frame from the previously reconstructed reference frames having a second lowest frame level quantization parameter is greater than a cardinality of the set of available transform types divided by two; and
the frame level quantization parameter of the current frame is less than or equal to a third defined threshold, wherein the third defined threshold is a product of multiplying a sum of two hundred fourth and a result of subtracting eight from a bit depth for the current frame by twenty-four:
determining, as the subset cardinality, half of the cardinality of the set of available transform types.

13. The method of claim 12, wherein obtaining the reconstructed block data includes:
accessing a binary symbol and a quaternary symbol, collectively representing the current transform type, from the encoded bitstream.

14. The method of claim 8, wherein determining the subset cardinality includes:
in response to determining that:
a cardinality of the previously reconstructed reference frames is greater than or equal to a first defined threshold;
the frame level quantization parameter of the current frame is greater than the frame level quantization parameters of the first defined cardinality of the previously reconstructed reference frames in ascending frame level quantization parameter order;
the frame level quantization parameter of the current frame is less than or equal to the frame level quantization parameters of a second defined cardinality of the previously reconstructed reference frames in ascending frame level quantization parameter order;
at least one of the frame level quantization parameter of the current frame is greater than the frame level quantization parameters of the second defined cardinality of the previously reconstructed reference frames in ascending frame level quantization parameter order or the frame level quantization parameter of the current frame is greater than a second defined threshold, wherein the second defined threshold is a product of multiplying a sum of one hundred ninety-two and a result of subtracting eight from a bit depth for the current frame by twenty-four; and
at least one of:
a cardinality of transform types used for encoding a previously reconstructed reference frame from the previously reconstructed reference frames having a second lowest frame level quantization parameter is less than or equal to a cardinality of the set of available transform types divided by two; or
the frame level quantization parameter of the current frame is greater than a third defined threshold, wherein the third defined threshold is a product of multiplying a sum of two hundred fourth and a result of subtracting eight from a bit depth for the current frame by twenty-four,
determining, as the subset cardinality, a quarter of the cardinality of the set of available transform types.

15. The method of claim 14, wherein obtaining the reconstructed block data includes:
accessing a quaternary symbol representing the current transform type from the encoded bitstream.

16. A method comprising:
obtaining an encoded bitstream by encoding a current block of a current frame of a current sequence of frames of an input video stream using adaptive transform type sets based on frame level statistics, wherein encoding the current block includes:
obtaining transform type statistics for previously reconstructed reference frames from the current sequence of frames, the previously reconstructed reference frames including at least one previously reconstructed reference frame;
determining, in accordance with the transform type statistics, a current subset of transform types from a set of available transform types;
generating encoded block data for the current block using a current transform type from the current subset of transform types; and
including the encoded block data in the encoded bitstream; and
outputting the encoded bitstream.

17. The method of claim 16, wherein determining the current subset of transform types includes determining a subset cardinality for the current subset of transform types indicating how many transform types to include in the current subset of transform types, wherein:
determining the subset cardinality includes:
in response to determining that a frame level quantization parameter of the current frame is less than or equal to a frame level quantization parameters of a first defined cardinality of the previously reconstructed reference frames in ascending frame level quantization parameter order, determining, as the subset cardinality, a cardinality of the current subset of transform types; and
in response to determining that:
a cardinality of the previously reconstructed reference frames is greater than or equal to a first defined threshold;
the frame level quantization parameter of the current frame is greater than the frame level quantization parameters of the first defined cardinality of the previously reconstructed reference frames in ascending frame level quantization parameter order;
the frame level quantization parameter of the current frame is less than or equal to the frame level quantization parameters of a second defined cardinality of the previously reconstructed reference frames in ascending frame level quantization parameter order;
at least one of the frame level quantization parameter of the current frame is greater than the frame level quantization parameters of the second defined cardinality of the previously reconstructed reference frames in ascending frame level quantization parameter order or the frame level quantization parameter of the current frame is greater than a second defined threshold, wherein the second defined threshold is a product of multiplying a sum of one hundred ninety-two and a result of subtracting eight from a bit depth for the current frame by twenty-four;
a cardinality of transform types used for encoding a previously reconstructed reference frame from the previously reconstructed reference frames having a second lowest frame level quantization parameter is greater than a cardinality of the set of available transform types divided by two; and
the frame level quantization parameter of the current frame is less than or equal to a third defined threshold, wherein the third defined threshold is a product of multiplying a sum of two hundred fourth and a result of subtracting eight from a bit depth for the current frame by twenty-four,
determining, as the subset cardinality, half of the cardinality of the set of available transform types.

18. A non-transitory computer-readable storage medium storing an encoded bitstream comprising:
encoded block data encoded using a transform type from a subset of available transform types, wherein the subset of available transform types has a cardinality determined in accordance with transform type statistics for previously reconstructed reference frames from a current sequence of frames, the previously reconstructed reference frames including at least one previously reconstructed reference frame.

19. The non-transitory computer-readable storage medium of claim 18, wherein the encoded bitstream includes:
a first quaternary symbol and a second quaternary symbol, collectively representing the transform type;
a ternary symbol and a quaternary symbol, collectively representing the transform type; or
a binary symbol and a quaternary symbol, collectively representing the transform type.

20. The non-transitory computer-readable storage medium of claim 18, wherein the encoded bitstream includes:
a quaternary symbol representing the transform type.
